(19) United States
(12) Patent Application Publication
(10) Pub. No.: US 2024/0279520 A1
(43) Pub. Date: Aug. 22, 2024

(54) FLUORINE SUBSTITUTED ETHERS AND COMPOSITIONS, METHODS AND USES INCLUDING SAME

(71) Applicant: Honeywell International Inc., Charlotte, NC (US)

(72) Inventors: Yian Zhai, Lockport, NY (US); Sudharsanam Ramanathan, Buffalo, NY (US); Pramod K.W. Harikumar Warrier, Cheektowaga, NY (US); Alexey Kruglov, Belmont, WA (US); Dimitrios Papanastasiou, Buffalo, NY (US); Christophe Roger, Buffalo, NY (US)

(21) Appl. No.: 18/379,954

(22) Filed: Oct. 13, 2023

Related U.S. Application Data
(60) Provisional application No. 63/415,683, filed on Oct. 13, 2022.

(51) Int. Cl. C09K 5/04

(52) U.S. Cl. CPC C09K 5/041; C09K 2205/112

(57) ABSTRACT

The fluoroether 3-(difluoromethoxy)-1,1,1,2,2-pentafluoropropane (“HFE-347mcf”) may be used as a refrigerant and/or heat transfer composition, such as in single phase and two phase cooling systems, and a method of heating and/or cooling an electronic component or device includes providing a heat transfer fluid comprising at least about 10% by weight of 3-(difluoromethoxy)-1,1,1,2,2-pentafluoropropane, and transferring heat between the electronic component and the heat transfer fluid. The fluoroether 3-(difluoromethoxy)-1,1,1,2,2-pentafluoropropane may be synthesized by reacting 2,2,3,3,3-pentafluoro-1-propanol with chlorodifluoromethane (R-22).

### CROSS REFERENCE TO RELATED APPLICATIONS

This application claims the benefit under Title 35, U.S.C. § 119(e) of U.S. Provisional Patent Application Ser. No. 63/415,683, entitled “Fluorine substituted ethers derived from chlorodifluoromethane (R22), compositions, methods and uses including same”, filed on Oct. 13, 2022, the entire disclosure of which is expressly incorporated by reference herein.

### FIELD

The present disclosure is directed to fluorine substituted ethers, compositions comprising such ethers such as refrigerants and/or heat transfer compositions, and methods and uses including same including thermal management of electronic devices, such as immersion cooling.

### BACKGROUND

There continues to be a need for inert fluorinated compounds which have low global warming potential while providing high thermal stability, low toxicity, nonflammability, good solvency, and a wide operating temperature range to meet the requirements of various applications.

Applicants have come to appreciate that many challenging issues are associated with the development of new compounds and compositions for use in many important applications. In particular, applicants have come to appreciate the need for compositions, methods and systems which are at once environmentally acceptable (low GWP and low ODP), non-flammable, have low or no toxicity, and have excellent properties needed for the particular application (for example, good solvency for vapor degreasing, or low dielectric constant if the application involves exposure or potential exposure to electronic equipment or components). A need also continues to exist for improved compounds to transfer heat and/or mange the temperature of devices and articles, including in portable and hand-held electronic devices where the desire to miniaturize while adding functionality increases the thermal power density of the device while in operation, thus making cooling of the electronics components within such devices, including batteries, more challenging. As general rule increases in computational power within desktop computers, data centers, telecommunication centers and the like results in an increase in the heat output when such devices are operating, again making thermal management of such electronic devices increasingly important and increasingly more difficult and demanding. Other examples of thermal management challenges occur as a result of the increasing use of electronic vehicles, including particularly, cars, trucks, motorcycles and the like. In electric vehicles the thermal management function is especially important and challenging for several reasons, including the criticality of cooling and/or heating the batteries to be within a relatively narrow temperature range and in a way that is reliable, efficient and safe, and the challenge to provide effective thermal battery management is becoming greater as the demand for battery-operated vehicles with greater range and faster charging increases.

The efficiency and effectiveness of batteries, especially the batteries that provide the power in electronic vehicles, is a function of the operating temperature at which they operate. Thus, thermal management system must frequently be able to do more than simply remove heat from the battery during operation and/or charging—it must be able to effect cooling in a relatively narrow temperature range using equipment that is as low cost as possible and as light weight as possible. This results in the need for a heat transfer composition in such systems that possesses a difficult-to-achieve combination of physical and performance properties. Furthermore, in some important applications the thermal management system must be able to add heat to the battery, especially as the vehicle is started in cold weather, which adds further to the difficulty of discovering and developing/obtaining compounds and/or compositions effective in such systems, not only from a thermal performance standpoint, but also a myriad of other standpoints, including environmental, safety (flammability and toxicity), dielectric properties, and others.

As a particular example of the importance of dielectric constant, one frequently used system for the thermal management of electric vehicle batteries involves immersing the battery in the composition used for thermal management. Such systems add the additional constraint that the composition used in such systems must be electronically compatible with the intimate contact with the battery, or other electronic device or component, while the battery or device is in operation. In general, this means the composition must not only be non-flammable, but it must also have a low electrical conductivity and a high level of stability while in contact with the battery or other electronic component(s) while the component(s) are operating and at the relatively high temperatures existing during operation. Applicants have come to appreciate the desirability of such properties even in indirect cooling of operating electronic devices and batteries because leakage of any such composition may result in contact with operating electronic components.

Another example of the challenge in providing refrigerants for thermal management is the increasing use of electronic vehicles, including particularly, cars, trucks, motorcycles and the like. In electric vehicles the thermal management function is especially important and challenging for several reasons, including the criticality of cooling and/or heating the batteries to be within a relatively narrow temperature range and in a way that is reliable, efficient and safe, and the challenge to provide effective thermal battery management is becoming greater as the demand for battery-operated vehicles with greater range and faster charging increases.

Perfluorinated compounds have heretofore frequently been used in many of these demanding applications. In addition, other thermal management compositions which have been commonly used for battery cooling, including immersive cooling, is a water/glycol combination, although still other classes of materials, including some chlorofluorocarbons, fluorohydrocarbons, chlorohydrocarbons and hydrofluoroethers, have been mentioned for possible use. See, for example, US 2018/0191038.

Fluorinated ether compounds according to the formula

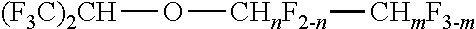

where n is 1 or 2, and where m is any integer of 0 to 3 when n is 1, but when n is 2, then m is 0 or 2 have been suggested for use as solvents, particularly for various fluorine-containing polyethers. See JP202105950. This document indicates that an embodiment of the above formula that is said to have a 3-1 configuration (understood to mean that m=3 and n=1) have additional uses, including as a draining agent, blowing agent, heat transfer media and fire extinguishing agent, although no such uses are specifically described or exemplified.

Thus, applicants have come to appreciate the need, among the other needs described herein, for thermal management methods and systems which use a heat transfer composition which is environmentally acceptable (low GWP and low ODP), non-flammable, has low or no toxicity, has excellent insulating properties and has thermal properties that provide effective cooling and/or heat, including at relatively high temperatures and/or for use in operating electronic components in a relatively narrow temperature range with equipment that is preferably low cost, reliable and light weight, among other uses.

Other applications of fluorinated ether compounds include aerosol propellants, blowing agents, gaseous dielectrics, fire suppression agents, solvents, cleaning agents, aerosol propellants, power cycle working fluids, and starting materials for producing other organofluorine compounds.

### SUMMARY

The present disclosure is based on the discovery that certain fluorinated ethers, including in particular 3-(difluoromethoxy)-1,1,2,2-tetrafluoropropane, 3-(difluoromethoxy)-1,1,1,2,2-pentafluoropropane (sometimes referred to herein as “HFE-347mcf”), 2-(difluoromethoxy)-1,1,1,3,3,3-hexafluoropropane, and 4-(difluoromethoxy)-1,1,1,2,2,3,3-heptafluorobutane, may be used as refrigerants and/or in heat transfer compositions, among other applications disclosed herein.

In one form thereof, the present disclosure provides a method of providing heat transfer to and/or from an electronic component, article and/or device while the electronic component, article and/or device is operating comprising: providing a heat transfer composition comprising at least about 10% by weight of 3-(difluoromethoxy)-1,1,1,2,2-pentafluoropropane; and contacting the heat transfer composition with the electronic component, article and/or device while it is in operation to cool the electronic component, article and/or device.

In another form thereof, the present disclosure provides a method of heating and/or cooling an electronic component, article and/or device while the electronic component, article and/or device is operating comprising: (a) providing a heat transfer composition comprising at least about 10% by weight of 3-(difluoromethoxy)-1,1,1,2,2-pentafluoropropane; (b) immersing the electronic component, article and/or device while the electronic component, article and/or device is operating in the heat transfer composition; and (c) transferring heat between the immersed electronic component, article and/or and the heat transfer composition.

In a further form thereof, the present disclosure provides a method for synthesizing 3-(difluoromethoxy)-1,1,1,2,2-pentafluoropropane by reacting 2,2,3,3,3-pentafluoro-1-propanol with chlorodifluoromethane in the presence of a base.

The present disclosure further provides 3-(difluoromethoxy)-1,1,2,2-tetrafluoropropane (Compound 1) and compositions comprising same (Composition 1).

The present disclosure also provides 3-(difluoromethoxy)-1,1,1,2,2-pentafluoropropane (sometimes referred to herein as “HFE-347mcf”) (Compound 2) and compositions comprising same (Composition 2).

The present disclosure also provides 2-(difluoromethoxy)-1,1,1,3,3,3-hexafluoropropane (Compound 3) and compositions comprising same (Composition 3).

The present disclosure also provides and 4-(difluoromethoxy)-1,1,1,2,2,3,3-heptafluorobutane (Compound 4) and compositions comprising same (Composition 4).

The present disclosure also provides a heat transfer composition comprising HFE-347mcf. Heat transfer compositions according to this paragraph are sometimes referred to herein for convenience as Heat Transfer Composition 1.

The present disclosure also provides a heat transfer composition comprising at least about 10% by weight of HFE-347mcf. Heat transfer compositions according to this paragraph are sometimes referred to herein for convenience as Heat Transfer Composition 2.

The present disclosure also provides a heat transfer composition comprising at least about 50% by weight of HFE-347mcf. Heat transfer compositions according to this paragraph are sometimes referred to herein for convenience as Heat Transfer Composition 3.

The present disclosure also provides a heat transfer composition comprising at least about 75% by weight of HFE-347mcf. Heat transfer compositions according to this paragraph are sometimes referred to herein for convenience as Heat Transfer Composition 4.

The present disclosure also provides a heat transfer composition comprising at least about 90% by weight of HFE-347mcf. Heat transfer compositions according to this paragraph are sometimes referred to herein for convenience as Heat Transfer Composition 5.

The present disclosure also provides a heat transfer composition consisting essentially of HFE-347mcf. Heat transfer compositions according to this paragraph are sometimes referred to herein for convenience as Heat Transfer Composition 6.

The present disclosure also provides a heat transfer composition consisting of HFE-347mcf. Heat transfer compositions according to this paragraph are sometimes referred to herein for convenience as Heat Transfer Composition 7.

The present disclosure also provides a heat transfer composition comprising Compound 1, sometimes referred to herein for convenience as Heat Transfer Composition 8.

The present disclosure also provides a heat transfer composition comprising Compound 3, sometimes referred to herein for convenience as Heat Transfer Composition 9.

The present disclosure also provides a heat transfer composition comprising Compound 4, sometimes referred to herein for convenience as Heat Transfer Composition 10.

### BRIEF DESCRIPTION OF THE DRAWINGS

The above mentioned and other features of the disclosure, and the manner of attaining them, will become more apparent and the disclosure itself will be better understood by reference to the following description of embodiments of the disclosure taken in conjunction with the accompanying drawings.

FIG. 1 is a schematic representation of a thermal management system of the present disclosure.

FIG. 2A is a schematic representation of a first exemplary immersion cooling system according to the present disclosure.

FIG. 2B is a schematic representation of a second exemplary immersion cooling system according to the present disclosure.

FIG. 3 is a schematic illustration of a battery thermal management system according to one embodiment of the present disclosure.

FIG. 4 is a photograph showing a battery thermal management system according to one embodiment of the present disclosure.

FIG. 5 is a schematic diagram of an exemplary organic Rankine cycle.

FIG. 6 is a schematic diagram of an exemplary heat pump.

FIG. 7 is a schematic diagram of an exemplary secondary loop system.

FIG. 8 is a semi-schematic drawing of one example of a lithium-ion battery cooling system using a composition of the present disclosure.

FIG. 9 is a semi-schematic drawing of one example of a lithium-ion battery having an electrolyte formulation of the present disclosure.

FIG. 10 is a semi-schematic drawing of a heat pipe using a heat transfer composition of the present disclosure.

The exemplification set out herein illustrates an embodiment of the disclosure, and such exemplification is not to be construed as limiting the scope of the disclosure in any manner.

### DETAILED DESCRIPTION

### I. Definitions

TABLE 1
Names of compounds as used herein
and corresponding chemical names

| Name | Chemical Name | Formula |
|---|---|---|
| R22 | Chlorodifluoromethane | CHClF₂ |
| Compound 1 | 3-(difluoromethoxy)-1,1,2,2- | CHF₂CF₂CH₂OCHF₂ |
| | tetrafluoropropane | |
| Compound 2 | 3-(difluoromethoxy)-1,1,1,2,2- | CF₃CF₂CH₂OCHF₂ |
| | pentafluoropropane | |
| | (“HFE-347mcf”, CAS# | |
| | 56860-81-2) | |
| Compound 3 | 2-(difluoromethoxy)- | (CF₃)₂CHOCHF₂ |
| | 1,1,1,3,3,3- | |
| | hexafluoropropane | |
| Compound 4 | 4-(difluoromethoxy)- | CF₃CF₂CF₂CH₂OCHF₂ |
| | 1,1,1,2,2,3,3- | |
| | heptafluorobutane | |

“Electronic Device”, and related word forms, means a device, or a component of a device, which is in the process of performing its intended function by receiving, and/or transmitting and/or producing electrical energy and/or electronic signals, such as a battery, electric vehicle battery, data center, or integrated circuit, for example. Thus, the term “operating electronic device” as used herein includes, for example, a battery which is in the process of providing a source of electrical energy to another component and also a battery which is being charged or recharged, for example.

“Operating Electronic Device”, and related word forms, means a device, or a component of a device, which is in the process of performing its intended function by receiving, and/or transmitting and/or producing electrical energy and/or electronic signals. Thus, the term “operating electronic device” as used herein includes, for example, a battery which is in the process of providing a source of electrical energy to another component and also a battery which is being charged or recharged, including electric vehicle batteries, as well as data centers and integrated circuits.

The term “Heat Transfer Composition” and related word forms means a composition in the form of a fluid (liquid or gas) which is used to transfer heat or energy from one fluid, article or device to another fluid, article or device, and thus includes for example refrigerants, thermal management compositions and working fluids for Rankine cycles.

When a heat transfer composition is used in thermal management to keep a device or article within a particular temperature range (e.g., in electronic cooling), it is sometimes referred herein as a thermal management composition.

The component(s) that are present in a heat transfer composition for the purpose of transferring heat (as opposed to, for example, providing lubrication or stabilization) in a heat transfer system (e.g., a vapour compression heat transfer system), that component or combination of components are sometimes referred to herein as a refrigerant.

The term “Rankine cycle” as used herein refers to systems which include: 1) a boiler to change liquid to vapor at high pressure; 2) a turbine to expand the vapor to derive mechanical energy; 3) a condenser to change low pressure exhaust vapor from the turbine to low pressure liquid; and 4) a pump to move condensate liquid back to the boiler at high pressure. Such systems are commonly used for electrical power generation.

“Thermal contact”, and related forms thereof, includes direct contact with the surface and indirect contact though another body or fluid which facilitates the flow of heat between the surface and the fluid.

“Thermal conductivity” refers to the breakdown voltage in kV as measured in accordance with ASTM D7896-19.

Global Warming Potential (“GWP”) was developed to allow comparisons of the global warming impact of different gases. It is a measure of how much energy the emission of one ton of a gas will absorb over a given period of time, relative to the emission of one ton of carbon dioxide. The larger GWP, the more that a given gas warms the Earth compared to CO2 over that time period. The time period usually used for GWP is 100 years. GWP provides a common measure, which allows analysts to add up emission estimates of different gases.

The term “AMES-negative” refers to a compound or composition which returns a negative result when tested under the Ames test as specified in the Toxic Substances Control Act of the United States.

“Flash Point” refers the lowest temperature at which vapors of the liquid will keep burning after the ignition source is removed as determined in accordance with ASTM D3828-16a.

“Non-flammable” in the context of heat transfer compositions, including thermal management composition or fluid, means compounds or compositions which do not have a flash point below 100° F. (37.8° C.) in accordance with NFPA 30: Flammable and Combustible Liquid Code. The flash point of a thermal management composition or fluid refers the lowest temperature at which vapours of the composition will keep burning after the ignition source is removed as determined in accordance with ASTM D3828-16a.

In the context of a refrigerant composition, a compound or composition which is non-flammable and low or no-toxicity would be classified as “A1” by ASHRAE Standard 34-2016 Designation and Safety Classification of Refrigerants and described in Appendix B1 to ASHRAE Standard 34-2016.

“No or low toxicity” means a fluid classified as class “A” by ASHRAE Standard 34-2016 Designation and Safety Classification of Refrigerants and described in Appendix B1 to ASHRAE Standard 34-2016.

“Capacity” is the amount of cooling provided, in BTUs/hr, by the refrigerant in the refrigeration system. This is experimentally determined by multiplying the change in enthalpy in BTU/lb, of the refrigerant as it passes through the evaporator by the mass flow rate of the refrigerant. The enthalpy can be determined from the measurement of the pressure and temperature of the refrigerant. The capacity of the refrigeration system relates to the ability to maintain an area to be cooled at a specific temperature. The capacity of a refrigerant represents the amount of cooling or heating that it provides and provides some measure of the capability of a compressor to pump quantities of heat for a given volumetric flow rate of refrigerant. In other words, given a specific compressor, a refrigerant with a higher capacity will deliver more cooling or heating power.

Coefficient of Performance (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

“Vapor degreasing” means a surface-cleaning process that uses solvent vapors to wash oils and other contaminants off of articles or parts of articles.

“Dielectric Constant” means the dielectric constant as measured at room temperature at 20 giga hertz (GHz).

“Dielectric strength” refers to the breakdown voltage in kV as measured in accordance with ASTM D87-13, Procedure A, with the modification that the spacing between the electrodes is 2.54 mm and the rate of rise was 500 V/sec.

The terms “R-1132(E)”, “HFO-1132(E)” and “transHFO-1132(E)” each means the trans isomer of 1,2-difluorethylene.

The terms “R-1132a” and “HFO-1132a” each means 1,1-difluoroethylene.

The terms “R-1234yf” and “HFO-1234yf” mean 2,3,3,3-tetrafluoropropene.

The terms “R-1234ze(E)” and “HFO-1234ze(E)” means the trans isomer of 1,3,3,3-tetrafluoropropene.

The terms “R-1233zd(E)” and “HFCO-1233zd(E)” mean the trans isomer of 1-chloro-3,3,3-trifluoropropene.

The terms “R-1233zd(Z)” and “HFCO-1233zd(Z)” mean the cis isomer of 1-chloro-3,3,3-trifluoropropene.

The terms “R-1224yd(E)” and “HFCO-1224yd(E)” mean the trans isomer of 1-chloro-2,3,3,3-tetrafluoropropane.

The terms “R-1224yd(Z)” and “HFCO-1224yd(Z)” mean the cis isomer of 1-chloro-2,3,3,3-tetrafluoropropane.

The terms “R-1336mzz(E)” and “HFO-1336mzz(E)” mean the trans isomer of 1,1,1,4,4,4-hexafluoro-2-butene.

The term “HFE-7000” means 1-methoxyheptafluoropropane (C₃F₇OCH₃).

The term “HFE-7100” means 1-methoxy-nonafluorobutane (C₄F₉OCH₃).

The term “HFE-7200” means ethoxy-nonafluorobutane (C₄F₉OC₂H₅).

The term “HFE-7300” means 1,1,1,2,2,3,4,5,5,5-decafluoro-3-methoxy-4-trifluoromethylpentane.

The term “HFE-7500” means 2-trifluoromethyl3-ethoxydodecofluorohexane.

As used herein, the singular forms “a”, “an”, and “the” include plural references unless the context clearly dictates otherwise.

As used herein, the recitation of numerical ranges by endpoints includes all numbers subsumed within that range (e.g., 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

As used herein, the phrase “within any range encompassing any two of these values as endpoints” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### II. Synthesis and Properties of the Present Fluoroethers

The present disclosure pertains to the synthesis of fluoroether compounds according to the following Formula 1:

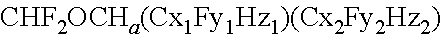

wherein a=1 or 2;
x₁ is from 1 to 4;
y₁ is from 3 to 9;
z₁ is from 0 to 6;
x₂ is from 0 to 3;
y₂ is from 0 to 7; and
z₂ is from 0 to 4.

The fluoroethers of Formula I above may be synthesized from any suitable fluoroalcohol and chlorodifluoromethane (R22) in one step as shown Scheme 1 below.

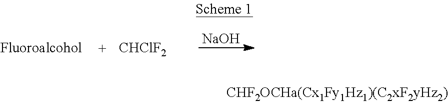

The starting materials for the reaction may include R22 and any suitable fluoroalcohol. Suitable fluoroalcohols include 2,2,3,3-tetrafluoro-1-propanol, 2,2,3,3,3-pentafluoro-1-propanol, 2,2,2,3,3,3-hexafluoro-1-propanol, and 2,2,3,3,4,4,4-heptafluoro-1-butanol.

The fluoroether product may be any of 3-(difluoromethoxy)-1,1,2,2-tetrafluoropropane, 3-(difluoromethoxy)-1,1,1,2,2-pentafluoropropane, 2-(difluoromethoxy)-1,1,1,3,3,3-hexafluoropropane, or 4-(difluoromethoxy)-1,1,1,2,2,3,3-heptafluorobutane.

A summary of the fluoroether products contemplated by the present disclosure, their respective fluoroalcohol starting materials, and their physical properties is provided below in Table 2.

TABLE 2
Fluoroalcohol starting materials and physical properties of fluoroethers

| | | Physical Properties of Fluoroether Product | | | | |
|---|---|---|---|---|---|---|
| | Fluoroalcohol | Boiling | | Dielectric | | |
| | Starting | point | | Constant | | |
| Fluoroether | Material | (° C.) | Density | (20 GHz) | GWP | ODP |
| 3-(difluoromethoxy)- | 2,2,3,3- | 76 | 1.3-1.7 | 4.0 | 484 | 0 |
| 1,1,2,2- | tetrafluoro-1- | | | | | |
| tetrafluoropropane | propanol | | | | | |
| (Compound 1) | | | | | | |
| 3-(difluoromethoxy)- | 2,2,3,3,3- | 46 | 1.3-1.7 | 3.4 | <500 | 0 |
| 1,1,1,2,2- | pentafluoro-1- | | | | | |
| pentafluoropropane | propanol | | | | | |
| (Compound 2) | | | | | | |
| 2-(difluoromethoxy)- | 2,2,2,3,3,3- | 41 | 1.3-1.7 | <5 | 3040 | 0 |
| 1,1,1,3,3,3- | hexafluoro-1- | | | | | |
| hexafluoropropane | propanol | | | | | |
| (Compound 3) | | | | | | |
| 4-(difluoromethoxy)- | 2,2,3,3,4,4,4- | 69 | 1.3-1.7 | 2.8 | <600 | 0 |
| 1,1,1,2,2,3,3- | heptafluoro-1- | | | | | |
| heptafluorobutane | butanol | | | | | |
| (Compound 4) | | | | | | |

The starting fluoroalcohol and R22 may be present in a stoichiometric ratio of 0.8:1.2 to 1.2:0.8.

The reaction may be carried out in an organic solvent such as dimethylformamide (DMF), acetone, acetonitrile, dimethylsulfoxide (DMSO), tetrahydrofuran (THF), isopropanol, ethanol, and methanol, among others.

The reaction may be catalyzed by a base such as NaOH or KOH.

The reaction may be carried out in a reactor that uses a sufficient level of agitation to create a homogenous reaction mixture. Suitable agitation can be achieved by using a mechanical stirrer or magnetic stir bar. The reactor vessel may be coupled to a heating medium to maintain an appropriate reaction temperature. The reactor vessel may be coupled to a cooling bath with any suitable cooling medium to maintain a suitable reaction temperature. The reactor vessel may also be coupled to a condenser with a cooling medium to condense solvent vapors.

The entire reaction may also be conducted in an autoclave at increased pressure such as less than 300 psig.

The reaction may be carried out at a temperature as low as 0° C., 5° C., 10° C., 15° C., 20° C., 25° C. or as high as 30° C., 35° C., 40° C., 45° C., 50° C. or within any range encompassed by any two of the foregoing values as endpoints. For example, the reaction may be carried out a temperature of 10-25° C.

Compounds 1-4 and/or Heat Transfer Compositions 1-10 may have a boiling point a boiling point of from about 35° C. to about 80° C., such as about 46° C.

Compounds 1-4 and/or Heat Transfer Compositions 1-10 may have a dielectric constant less than about 5 at 20 GHz, such as about 3.4 at 20 GHz.

Compounds 1-4 and/or Heat Transfer Compositions 1-10 may be non-flammable.

### III. Applications

The compounds and compositions of the present disclosure, including each of Compounds 1-4 and Compositions 1-4, may be used for a variety of applications including but not limited to heat transfer compositions, thermal management compositions, refrigerants, aerosol propellants, blowing agents, heat transfer media, gaseous dielectrics, fire suppression agents, solvents, cleaning agents, aerosol propellants, power cycle working fluids, and starting materials for producing other organofluorine compounds.

In heat transfer applications, Compounds 1-4 and/or Heat Transfer Compositions 1-10 of the present disclosure may also be used with a variety of co-refrigerants (or co-thermal transfer fluids). Preferred co-refrigerants include hexafluoroisopropylethylether, hexafluoroisopropylmethylthioether, HFE-7000, HFE-7200, HFE-7100, HFE-7500, trans-1,2-dichloroethylene, n-pentane, cyclopentane, ethanol, perfluoro(2-methyl-3-pentanone) (Novec 1230), cis-HFO-1336mzz, trans-HFO-1336mzz, HFO-1234yf, HFO-1234ze(E), HFO-1233zd(E) or HFO-1233zd(Z).

Table 3 below defines some preferred refrigerants which are blends comprising Compound 2 (HFE-347mcf) and at least one co-refrigerant. The first column of the table below identifies and defines the Refrigerant Blend by number as RB1, RB2, etc., and in that column the abbreviations COMP, CEO and CO are used to identify the nature of blend components identified in columns 2 and 3. In particular, the designation COMP in column 1 indicates that the refrigerant comprises Compound 2 and the indicated co-refrigerant. The designation CEO in column 1 means that the refrigerant consists essentially of Compound 2 and the designated co-refrigerant, and the designation CO in column 1 means that the refrigerant consists of Compound 2 and the designated co-refrigerant. The second column indicates the amount in weight percent Compound 2 required to be present in the blend with “=>” meaning equal to or greater. In the third column, the co-refrigerant is identified, and if a specific amount of the co-refrigerant in the blend is required, that is indicated as well, with “=<” meaning equal to or less than.

TABLE 3

| | wt % | |
|---|---|---|
| No. | Compound 2 | Co-refrigerant |
| RB1A - COMP | 0.1%-99.9% | hexafluoroisopropylethylether |
| RB1B - COMP | =>10% | hexafluoroisopropylethylether |
| RB1C - COMP | =>25% | hexafluoroisopropylethylether |
| RB1D1 - COMP | =>50% | hexafluoroisopropylethylether |
| RB1D2 - COMP | =>50% | =<50% hexafluoroiso- |
| | | propylethylether |
| RB1E - COMP | =>75% | hexafluoroisopropylethylether |
| RB1F - COMP | =>90% | hexafluoroisopropylethylether |
| RB1G - CEO | =>95% | hexafluoroisopropylethylether |
| RB1H - CO | =>95% | hexafluoroisopropylethylether |
| RB2A - COMP | 0.1%-99.9% | hexafluoroisopropylmethylthioether |
| RB2B - COMP | =>10% | hexafluoroisopropylmethylthioether |
| RB2C - COMP | =>25% | hexafluoroisopropylmethylthioether |
| RB2D1 - COMP | =>50% | hexafluoroisopropylmethylthioether |
| RB2D2 - COMP | =>50% | =<50% hexafluoroiso- |
| | | propylmethylthioether |
| RB2E - COMP | =>75% | hexafluoroisopropylmethylthioether |
| RB2F - COMP | =>90% | hexafluoroisopropylmethylthioether |
| RB2G - CEO | =>95% | hexafluoroisopropylmethylthioether |
| RB2H - CO | =>95% | hexafluoroisopropylmethylthioether |
| RB3A - COMP | 0.1%-99.9% | HFE-7000 |
| RB3B - COMP | =>10% | HFE-7000 |
| RB3C - COMP | =>25% | HFE-7000 |
| RB3D1 - COMP | =>50% | HFE-7000 |
| RB3D2 - COMP | =>50% | =<50% HFE-7000 |
| RB3E - COMP | =>75% | HFE-7000 |
| RB3F - COMP | =>90% | HFE-7000 |
| RB3G - CEO | =>95% | HFE-7000 |
| RB3H - CO | =>95% | HFE-7000 |
| RB4A - COMP | 0.1%-99.9% | HFE-7100 |
| RB4B - COMP | =>10% | HFE-7100 |
| RB4C - COMP | =>25% | HFE-7100 |
| RB4D1 - COMP | =>50% | HFE-7100 |
| RB4D2 - COMP | =>50% | =<50% HFE-7100 |
| RB4E - COMP | =>75% | HFE-7100 |
| RB4F - COMP | =>90% | HFE-7100 |
| RB4G - CEO | =>95% | HFE-7100 |
| RB4H - CO | =>95% | HFE-7100 |
| RB5A - COMP | 0.1%-99.9% | HFE-7200 |
| RB5B - COMP | =>10% | HFE-7200 |
| RB5C - COMP | =>25% | HFE-7200 |
| RB5D1 - COMP | =>50% | HFE-7200 |
| RB5D2 - COMP | =>50% | =<50% HFE-7200 |
| RB5E - COMP | =>75% | HFE-7200 |
| RB5F - COMP | =>90% | HFE-7200 |
| RB5G - CEO | =>95% | HFE-7200 |
| RB5H - CO | =>95% | HFE-7200 |
| RB6A - COMP | 0.1%-99.9% | HFE-7500 |
| RB6B - COMP | =>10% | HFE-7500 |
| RB6C - COMP | =>25% | HFE-7500 |
| RB6D1 - COMP | =>50% | HFE-7500 |
| RB6D2 - COMP | =>50% | =<50% HFE-7500 |
| RB6E - COMP | =>75% | HFE-7500 |
| RB6F - COMP | =>90% | HFE-7500 |
| RB6G - CEO | =>95% | HFE-7500 |
| RB6H - CO | =>95% | HFE-7500 |
| RB7A - COMP | 0.1%-99.9% | trans-1,2-dichloroethylene |
| RB7B - COMP | =>10% | trans-1,2-dichloroethylene |
| RB7C - COMP | =>25% | trans-1,2-dichloroethylene |
| RB7D1 - COMP | =>50% | trans-1,2-dichloroethylene |
| RB7D2 - COMP | =>50% | =<50% trans-1,2-dichloroethylene |
| RB7E - COMP | =>75% | trans-1,2-dichloroethylene |
| RB7F - COMP | =>90% | trans-1,2-dichloroethylene |
| RB7G - CEO | =>95% | trans-1,2-dichloroethylene |
| RB7H - CO | =>95% | trans-1,2-dichloroethylene |
| RB8A - COMP | 0.1%-99.9% | n-pentane |
| RB8B - COMP | =>10% | n-pentane |
| RB8C - COMP | =>25% | n-pentane |
| RB8D1 - COMP | =>50% | n-pentane |
| RB8D2 - COMP | =>50% | =<50% n-pentane |
| RB8E - COMP | =>75% | n-pentane |
| RB8F - COMP | =>90% | n-pentane |
| RB8G - CEO | =>95% | n-pentane |
| RB8H - CO | =>95% | n-pentane |
| RB9A - COMP | 0.1%-99.9% | cyclopentane |
| RB9B - COMP | =>10% | cyclopentane |
| RB9C - COMP | =>25% | cyclopentane |
| RB9D1 - COMP | =>50% | cyclopentane |
| RB9D2 - COMP | =>50% | =<50% cyclopentane |
| RB9E - COMP | =>75% | cyclopentane |
| RB9F - COMP | =>90% | cyclopentane |
| RB9G - CEO | =>95% | cyclopentane |
| RB9H - CO | =>95% | cyclopentane |
| RB10A - COMP | 0.1%-99.9% | ethanol |
| RB10B - COMP | =>10% | ethanol |
| RB10C - COMP | =>25% | ethanol |
| RB10D1 - COMP | =>50% | ethanol |
| RB10D2 - COMP | =>50% | =<50% ethanol |
| RB10E - COMP | =>75% | ethanol |
| RB10F - COMP | =>90% | ethanol |
| RB10G - CEO | =>95% | ethanol |
| RB10H - CO | =>95% | ethanol |
| RB11A - COMP | 0.1%-99.9% | perfluoro(2-methyl-3-pentanone) |
| RB11B - COMP | =>10% | perfluoro(2-methyl-3-pentanone) |
| RB11C - COMP | =>25% | perfluoro(2-methyl-3-pentanone) |
| RB11D1 - COMP | =>50% | perfluoro(2-methyl-3-pentanone) |
| RB11D2 - COMP | =>50% | =<50% perfluoro(2- |
| | | methyl-3-pentanone) |
| RB11E - COMP | =>75% | perfluoro(2-methyl-3-pentanone) |
| RB11F - COMP | =>90% | perfluoro(2-methyl-3-pentanone) |
| RB11G - CEO | =>95% | perfluoro(2-methyl-3-pentanone) |
| RB11H - CO | =>95% | perfluoro(2-methyl-3-pentanone) |
| RB12A - COMP | 0.1%-99.9% | HFO-1336mzz(Z) |
| RB12B - COMP | =>10% | HFO-1336mzz(Z) |
| RB12C - COMP | =>25% | HFO-1336mzz(Z) |
| RB12D1 - COMP | =>50% | HFO-1336mzz(Z) |
| RB12D2 - COMP | =>50% | =<50% HFO-1336mzz(Z) |
| RB12E - COMP | =>75% | HFO-1336mzz(Z) |
| RB12F - COMP | =>90% | HFO-1336mzz(Z) |
| RB12G - CEO | =>95% | HFO-1336mzz(Z) |
| RB12H - CO | =>95% | HFO-1336mzz(Z) |
| RB13A - COMP | 0.1%-99.9% | HFO-1336mzz(E) |
| RB13B - COMP | =>10% | HFO-1336mzz(E) |
| RB13C - COMP | =>25% | HFO-1336mzz(E) |
| RB13D1 - COMP | =>50% | HFO-1336mzz(E) |
| RB13D2 - COMP | =>50% | =<50% HFO-1336mzz(E) |
| RB13E - COMP | =>75% | HFO-1336mzz(E) |
| RB13F - COMP | =>90% | HFO-1336mzz(E) |
| RB13G - CEO | =>95% | HFO-1336mzz(E) |
| RB13H - CO | =>95% | HFO-1336mzz(E) |
| RB14A - COMP | 0.1%-99.9% | HFO-1234yf |
| RB14B - COMP | =>10% | HFO-1234yf |
| RB14C - COMP | =>25% | HFO-1234yf |
| RB14D1 - COMP | =>50% | HFO-1234yf |
| RB14D2 - COMP | =>50% | =<50% HFO-1234yf |
| RB14E - COMP | =>75% | HFO-1234yf |
| RB14F - COMP | =>90% | HFO-1234yf |
| RB14G - CEO | =>95% | HFO-1234yf |
| RB14H - CO | =>95% | HFO-1234yf |
| RB15A - COMP | 0.1%-99.9% | HFO-1234ze(E) |
| RB15B - COMP | =>10% | HFO-1234ze(E) |
| RB15C - COMP | =>25% | HFO-1234ze(E) |
| RB15D1 - COMP | =>50% | HFO-1234ze(E) |
| RB15D2 - COMP | =>50% | =<50% HFO-1234ze(E) |
| RB15E - COMP | =>75% | HFO-1234ze(E) |
| RB15F - COMP | =>90% | HFO-1234ze(E) |
| RB15G - CEO | =>95% | HFO-1234ze(E) |
| RB15H - CO | =>95% | HFO-1234ze(E) |
| RB16A - COMP | 0.1%-99.9% | HFO-1233zd(E) |
| RB16B - COMP | =>10% | HFO-1233zd(E) |
| RB16C - COMP | =>25% | HFO-1233zd(E) |
| RB16D1 - COMP | =>50% | HFO-1233zd(E) |
| RB16D2 - COMP | =>50% | =<50% HFO-1233zd(E) |
| RB16E - COMP | =>75% | HFO-1233zd(E) |
| RB16F - COMP | =>90% | HFO-1233zd(E) |
| RB16G - CEO | =>95% | HFO-1233zd(E) |
| RB16H - CO | =>95% | HFO-1233zd(E) |
| RB17A - COMP | 0.1%-99.9% | HFO-1233zd(Z) |
| RB17B - COMP | =>10% | HFO-1233zd(Z) |
| RB17C - COMP | =>25% | HFO-1233zd(Z) |
| RB17D1 - COMP | =>50% | HFO-1233zd(Z) |
| RB17D2 - COMP | =>50% | =<50% HFO-1233zd(Z) |
| RB17E - COMP | =>75% | HFO-1233zd(Z) |
| RB17F - COMP | =>90% | HFO-1233zd(Z) |
| RB17G - CEO | =>95% | HFO-1233zd(Z) |
| RB17H - CO | =>95% | HFO-1233zd(Z) |
| RB18A - COMP | 0.1%-99.9% | HFCO-1224yd |
| RB18B - COMP | =>10% | HFCO-1224yd |
| RB18C - COMP | =>25% | HFCO-1224yd |
| RB18D1 - COMP | =>50% | HFCO-1224yd |
| RB18D2 - COMP | =>50% | =<50% HFCO-1224yd |
| RB18E - COMP | =>75% | HFCO-1224yd |
| RB18F - COMP | =>90% | HFCO-1224yd |
| RB18G - CEO | =>95% | HFCO-1224yd |
| RB18H - CO | =>95% | HFCO-1224yd |
| RB19A - COMP | 0.1%-99.9% | HFO-1132(E) |
| RB19B - COMP | =>10% | HFO-1132(E) |
| RB19C - COMP | =>25% | HFO-1132(E) |
| RB19D1 - COMP | =>50% | HFO-1132(E) |
| RB19D2 - COMP | =>50% | =<50% HFO-1132(E) |
| RB19E - COMP | =>75% | HFO-1132(E) |
| RB19F - COMP | =>90% | HFO-1132(E) |
| RB19G - CEO | =>95% | HFO-1132(E) |
| RB19H - CO | =>95% | HFO-1132(E) |
| RB20A - COMP | 0.1%-99.9% | HFE-7300 |
| RB20B - COMP | =>10% | HFE-7300 |
| RB20C - COMP | =>25% | HFE-7300 |
| RB20D1 - COMP | =>50% | HFE-7300 |
| RB20D2 - COMP | =>50% | =<50% HFE-7300 |
| RB20E - COMP | =>75% | HFE-7300 |
| RB20F - COMP | =>90% | HFE-7300 |
| RB20G - CEO | =>95% | HFE-7300 |
| RB20H - CO | =>95% | HFE-7300 |

The present disclosure includes refrigerant blends of the present invention, including each of RB1-RB20, in which the refrigerant is non-flammable.

The present disclosure includes refrigerant blends of the present invention, including each of RB1-RB20, in which the refrigerant has a dielectric constant less than about 5 at 20 GHz.

The present disclosure includes refrigerant blends of the present invention, including each of RB1-RB20, in which the refrigerant has a dielectric constant less than about 4 at 20 GHz.

The present disclosure includes refrigerant blends of the present invention, including each of RB1-RB20, in which the refrigerant has a dielectric constant less than about 5 at 20 GHZ; (ii) has a boiling point of from about 35° C. to about 80° C.; (iii) is non-flammable; and (iv) has an Ames-negative toxicity.

The present disclosure includes refrigerant blends of the present invention, including each of RB1-RB20, in which the refrigerant has a boiling point of from about 35° C. to about 80° C.

Refrigerant blends of the present disclosure, including each of RB1-RB20, will be hereinafter referred to as Blends RB1-RB20.

As discussed above, in particular as described in Table 4, the Compounds 1-4 and/or Heat Transfer Compositions 1-10 and/or Blends RB1-RB20, can be advantageously used in a method or device or system of cooling and/or heating in an electronic device.

As discussed herein, when a heat transfer composition of the present disclosure, including each of Compounds 1-4 and/or Heat Transfer Compositions 1-10 and/or Blends RB1-RB20, is used in a method or device or system of cooling and/or heating in an electronic device, it is sometimes referred to herein as a thermal management composition. The thermal management composition therefore corresponds to the heat transfer composition as discussed in this application.

The Compounds 1-4 and/or Heat Transfer Compositions 1-10 and/or Blends RB1-RB20 are particularly useful as a heat transfer composition because of its low vapor pressure, low dielectric properties, high boiling point, and nonflammability. For example, Compounds 1-4 and/or Heat Transfer Compositions 1-10 and/or Blends RB1-RB20 may be used in data centers when excess amounts of heat cannot be controlled by air cooling alone, such as during data tsunamis. Compounds 1-4 and/or Heat Transfer Compositions 1-10 and/or Blends RB1-RB20 may be used for immersion cooling systems which remove heat effectively while maintaining data transfer integrity which is critical for micro processing devices.

These applications are discussed below:

### Heat Transfer Compositions

As mentioned above, the present disclosure provides various methods, processes, and uses of the presently disclosed compounds as heat transfer compositions. Compounds 1-4 and/or Heat Transfer Compositions 1-10 and/or Blends RB1-RB20 may be used to transmit heat from one location to another (or from one body, or article or fluid to another body, article or fluid). For example, the heat transfer compositions may be used to keep the temperature of a device below a defined upper and/or above a defined lower temperature. In another example, the heat transfer compositions may be used for energy conversion, as in the capture of waste heat from industrial or other processes and the conversion to electrical or mechanical energy.

Accordingly, the present disclosure encompasses various methods, processes and uses of the compounds of the present disclosure, including each of Compounds 1-4 and/or Heat Transfer Compositions 1-10 and/or Blends RB1-RB20 as thermal management compositions (hereinafter sometimes referred to as TMCs) that are used help maintain an article or device (preferably an electronic device or battery) or fluid within a certain temperature range, particularly as that article, device or fluid is operating according to its intended purpose. For example, the TMCs of the present disclosure may be used to keep the temperature of a device below a defined upper and/or above a defined lower temperature.

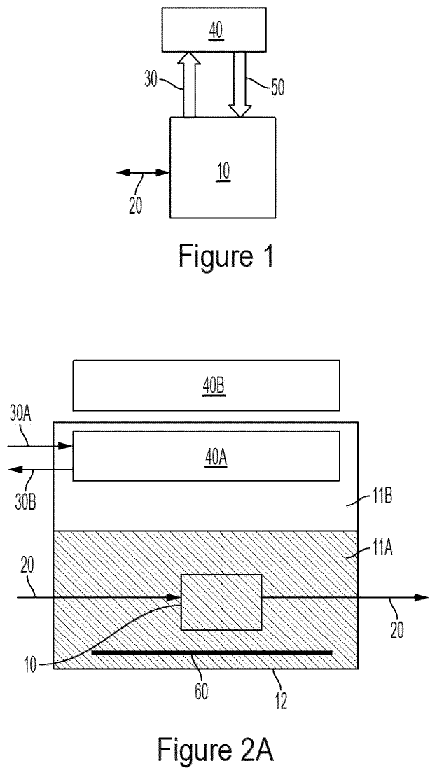

Preferred embodiments of the present thermal management methods, with FIG. 1 in which an operating electronic device is shown schematically as 10 having a source of electrical energy and/or signals 20 flowing into and/or out of the device 10 and which generates heat as a result of its operation based on the electrical energy and/or signals 20. The thermal management composition of the present disclosure is provided in thermal contact with the operating device 10 such that it removes heat, represented by the out flowing arrow 30. Heat is removed from the operating electronic device by sensible heat being added to the liquid thermal management composition of the present disclosure (i.e., increasing the temperature of the liquid), or by causing a phase change in the thermal management liquid (i.e., vaporizing the liquid) or a combination of these. In preferred embodiments, the methods provide a supply of TMC of the present disclosure, including each of Compounds 1-4 and/or Heat Transfer Compositions 1-10 and/or Blends RB1-RB20, to the device 10 such that the flow of heat from the device 10 through the present heat transfer composition 30 maintains the operating electrical device at or within a preferred operating temperature range. In preferred embodiments, the preferred operating temperature range of the electrical device is from about 70° C. to about 150° C., and even more preferably from about 70° C. to about 120° C., and the flow of heat 30 from the device 10 through the present heat transfer fluid energy maintains the operating electrical device at or within such preferred temperature ranges. Preferably, the TMC 30 of the present disclosure, which has absorbed heat from the device, is in thermal contact with a heat sink, represented schematically as 40, at a temperature below the temperature of the heat transfer composition 30 and thereby transfers the heat generated by the device 10 to the heat sink 40. In this way, the heat-depleted heat transfer fluid of the present disclosure 50 can be returned to the electronic device 10 to repeat the cycle of cooling.

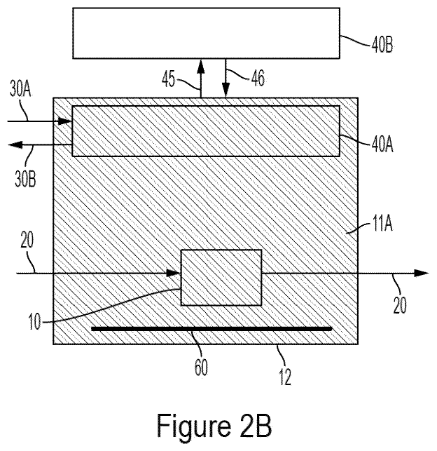

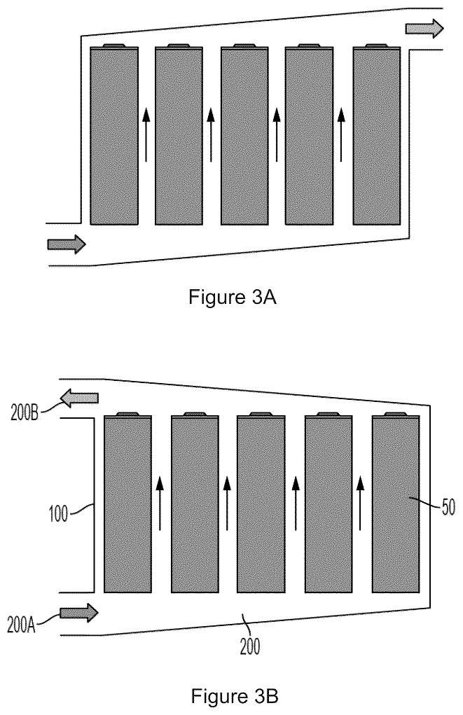

In a preferred embodiment of the present methods, the step of removing heat through a heat transfer composition of the present disclosure, including each of Compounds 1-4 and/or Heat Transfer Compositions 1-10 and/or Blends RB1-RB20, comprises evaporating the heat transfer composition of the present disclosure using the heat generated by the operation of the electronic device, and the step of transferring that heat from the heat transfer composition to the heat sink comprises condensing the heat transfer composition by rejecting heat to the heat sink. In such methods, the temperature of the heat transfer composition of the present disclosure, including each of Compounds 1-4 and/or Heat Transfer Compositions 1-10 and/or Blends RB1-RB20, during said evaporation step is preferably greater than 50° C., or preferably greater than about 55° C., or preferably in the range of from about 55° C. to about 85° C., or preferably from about 65° C. to about 75° C. Applicants have found that the present thermal management compositions, provide excellent performance in such methods and at the same time allow the use of relatively low cost, lightweight and reliable equipment to provide the necessary cooling, as will be explained further in connection with particular embodiments as described in connection with FIG. 2A below.

In a further preferred embodiment of the present methods, the step of removing heat through the present heat transfer composition, including each of Compounds 1-4 and/or Heat Transfer Compositions 1-10 and/or Blends RB1-RB20, comprises adding sensible heat to the liquid heat transfer composition of the present disclosure (e.g., raising the temperature of the liquid up to about 70° C. or less at about atmospheric pressure, i.e., wherein the fluid is not required to be in a high pressure container or vessel) using the heat generated by the operation of the electronic device, and the step of transferring that heat from the heat transfer composition to a heat sink and thereby reducing the liquid temperature by rejecting heat to the heat sink. The cooled liquid is then returned to thermal contact with the electrical device wherein the cycle starts over. In preferred embodiments, the temperature of the heat transfer liquid that is used to transfer heat to the heat sink is greater than about 40° C., or preferably greater than about 55° C., or preferably in the range of from about 45° C. to about 70° C., or preferably from about 45° C. to about 65° C., and preferably is at a pressure that is about atmospheric. Applicants have found that the present heat transfer liquids, including each of Compounds 1-4 and/or Heat Transfer Compositions 1-10 and/or Blends RB1-RB20, provide excellent performance in such methods and at the same time allow the use for relatively low cost, lightweight and reliable equipment to provide the necessary cooling, as will be explained further in connection with particular embodiments as described in connection with FIG. 2B below.

It will be appreciated by those skilled in the art that the present disclosure comprises systems and methods which use both sensible heat transfer and phase change heat transfer as describe above.

A particular method according to the present disclosure will now be described in connection with FIGS. 2A and 2B in which an electronic device 10 is contained in an appropriate container 12, and preferably a sealed container, and is in direct contact with, and preferably fully immersed in liquid heat transfer composition of the present disclosure 11A (shown schematically by gray shading), including each of Compounds 1-4 and/or Heat Transfer Compositions 1-10 and/or Blends RB1-RB20. For the purposes of convenience, such cooling methods, devices and system are sometimes referred to herein as “immersion cooling” methods, devices and systems.

In immersion cooling methods, devices and systems used to cool electrical devices or components, the operating electronic device 10 has a source of electrical energy and/or signals 20 flowing into and/or out of the container 12 and into and/or out of device 10, which generates heat as a result of its operation based on the electrical energy and/or signals 20. As those skilled in the art will appreciate, it is a significant challenge to discover a heat transfer composition that can perform effectively in such applications since the composition must not only provide all of the other properties mentioned above, but it must also be able to do so while in intimate contact with an operating electronic device, that is, one which involves the flow of electrical current/signals. It will be appreciated that many compounds that might be otherwise viable for use in such applications will not be useable because they will either short-out the device, degrade when exposed to the conditions created by the operation of the electronic device (i.e., degrade the cooling effect over time and/or the operating stability of the device), or have some other property detrimental to operation when in contact with an operating electronic device.

In contrast, the present methods produce excellent and unexpected results by providing the thermal management composition of the present disclosure, including each of Compounds 1-4 and/or Heat Transfer Compositions 1-10 and/or Blends RB1-RB20, in direct thermal and physical contact with the device 10 as it is operating. This heat of operation is safely and effectively transferred to the thermal management composition 11A, including each of Compounds 1-4 and/or Heat Transfer Compositions 1-10 and/or Blends RB1-RB20 by: (a) causing the liquid phase of the fluid to evaporate and form vapor 11B; or (b) raising the temperature of the liquid thermal management composition 11A; or (c) a combination of (a) and (b).

When the thermal management composition is a single-phase liquid, it will remain liquid when heated by the heat-generating component. Thus, the thermal management composition can be brought into contact with the heat generating component, resulting in the removal of the heat from the heat generating component and the production of a thermal management composition with a higher temperature. The thermal management composition is then transported to a secondary cooling loop, such as a radiator or another refrigerated system. An example of such a system is illustrated in FIG. 2, where the thermal management composition enters a battery pack enclosure containing a number of cells and exits the enclosure having taken up heat from the battery pack.

When the thermal management composition of the present disclosure, including each of Compounds 1-4 and/or Heat Transfer Compositions 1-10 and/or Blends RB1-RB20, is present in two phases, the heat-generating component is in thermal contact with the thermal management composition and transfers heat to the thermal management composition, resulting in the boiling of the thermal management composition. The thermal management composition is then condensed. An example of such a system is where the heat-generating component is immersed in the thermal management composition and an external cooling circuit condenses the boiling fluid into a liquid state.

In the case of the phase change heat transfer systems of the present disclosure, reference is made herein to FIG. 2A. In such an operation, heat is carried away from the device 10 as the liquid evaporates and the vapor rises through the remaining thermal management liquid, including each of Compounds 1-4 and/or Heat Transfer Compositions 1-10 and/or Blends RB1-RB20, in the container 12. The thermal management composition vapor 11B then rejects the heat it has absorbed to a heat sink 40, which can be an enclosed heat sink 40A and/or an external heat sink 40B. An example of a heat sink that is internal to the container 12 are condenser coils 30A and 30B with circulating liquid, such as water, at a temperature below the condensing temperature of the thermal management composition vapor. An example of a heat sink that is external to the container 12 would be passing relatively cool ambient air over the container 12 (which preferably in such case include cooling fins or the like), which will serve to condense the heat transfer vapor 11B on the interior surface of the container. As a result of this condensation, liquid thermal management composition is returned to the pool of liquid fluid 11A in which the device 10 remains immersed in operation.

In the case of a sensible heat transfer systems of the present disclosure, reference is made herein to FIG. 2B. In such an operation heat is carried away from the device as the temperature of liquid 11A, including each of Compounds 1-4 and/or Heat Transfer Compositions 1-10 and/or Blends RB1-RB20, increases upon accepting heat being generated by the device, which is immersed, and preferably substantially fully immersed in the thermal management composition 11A of the present disclosure. The higher temperature thermal management composition liquid 11A then rejects the heat it has absorbed to a heat sink 40, which can be an enclosed heat sink 40A and/or an external heat sink 40B. An example of a heat sink that is internal to the container 12 are cooling coils 30A and 30B with circulating liquid, such as water, at a temperature below the temperature of heated liquid. An example of a heat sink that is external to the container 12 would be removing heated liquid 11A from the container through a conduit 45 where it is thermally contacted with a cool fluid, such as might be provided by relatively cool ambient air, or cooled water or refrigerant, which will serve to lower the temperature of the liquid. Cooled liquid is then returned via conduit 46.

Optionally, but preferably in certain embodiments involving thermal management of the batteries used in electronic vehicles, the thermal management system includes a heating element which is able to heat the thermal management composition, including each of Compounds 1-4 and/or Heat Transfer Compositions 1-10 and/or Blends RB1-RB20, such as for example an electrical heating element 60 which is also immersed in the thermal management composition. As those skilled in the art will appreciate, the batteries in electronic vehicles (which would correspond to the operating electronic device 10 in FIGS. 2A and 2B) can reach relatively low temperatures while parked outside in the winter months in many geographical locations, and frequently such low temperature conditions are not desirable for battery operation. Accordingly, the thermal management system of the present disclosure can include sensors and control modules (not shown) which turn on the heating element when the battery temperature is below a predetermined level. In such a case, the heater 60 would be activated, the thermal management liquid 11A would be heated, and would in turn transfer this heat to the electronic device 10 until the minimum temperature is reached. Thereafter during operation, the thermal management composition of the present disclosure, including each of Compounds 1-4 and/or Heat Transfer Compositions 1-10 and/or Blends RB1-RB20, would serve the cooling function as described above.

For the purposes of this disclosure, the thermal management composition, including each of Compounds 1-4 and/or Heat Transfer Compositions 1-10 and/or Blends RB1-RB20, can be in direct contact with the heat-generating component or in indirect contact with the heat-generating component.

When the thermal management composition, including each of Compounds 1-4 and/or Heat Transfer Compositions 1-10 and/or Blends RB1-RB20, is in indirect contact with the heat-generating component, the thermal management composition can be used in a closed system in the electronic device, which may include at least two heat exchangers. When the thermal management composition is used to cool the heat-generating component, heat can be transferred from the component to the thermal management composition, usually through a heat exchanger in contact with at least a part of the component or the heat can be transferred to circulating air which can conduct the heat to a heat exchanger that is in thermal contact with the thermal management composition.

In a particularly preferred feature of the present disclosure, the thermal management composition, including each of Compounds 1-4 and/or Heat Transfer Compositions 1-10 and/or Blends RB1-RB20, is in direct contact with the heat-generating component. In particular, the heat generating component is fully or partially immersed in the thermal management composition. Preferably the heat generating component is fully immersed in the thermal management composition, including each of Compounds 1-4 and/or Heat Transfer Compositions 1-10 and/or Blends RB1-RB20. The thermal management composition, as a warmed fluid or as a vapor, can then be circulated to a heat exchanger which takes the heat from the fluid or vapor and transfers it to the outside environment by way of a heat sink such as ambient air or water cooled by ambient air or otherwise. After this heat transfer, the cooled thermal management composition (cooled or condensed) is recycled back into the system to cool the heat-generating component.

Electrical conductivity and/or dielectric strength of a thermal management composition becomes important if the fluid comes in direct contact with the electronic components of the electronic device (such as in direct immersion cooling), or if the thermal management composition leaks out of a cooling loop or is spilled during maintenance and comes in contact with the electrical circuits. Thus, the thermal management composition of the present disclosure, and each of the Compounds 1-4 and/or Heat Transfer Compositions 1-10 and/or Blends RB1-RB20, is preferably an electrically insulating thermal management composition.

The thermal management composition of the present disclosure, including each of including each of Compounds 1-4 and/or Heat Transfer Compositions 1-10 and/or Blends RB1-RB20, may be recirculated passively or actively in the device, for example by using mechanical equipment such as a pump. In a preferred feature of the present disclosure, the thermal management composition of the present disclosure, including each of including each of Compounds 1-4 and/or Heat Transfer Compositions 1-10 and/or Blends RB1-RB20, is recirculated passively in the device.

Passive recirculating systems work by transferring heat from the heat-generating component to the thermal management composition until it typically is vaporized, allowing the heated vapor to proceed to a heat exchange surface at which it transfers its heat to the heat exchanger surface and condenses back into a liquid. It will be appreciated that the heat exchange surface can be part of a separate heat exchange unit and/or can be integral with the container, as described above for example in connection with FIG. 2. The condensed liquid then returns, preferably fully passively by the force of gravity and/or a wicking structure, into the thermal management composition in contact with the heat-generating component. Thus, in a preferred feature of the disclosure, the step of transferring heat from the heat-generating component to the thermal management composition of the present disclosure, including each of including each of Compounds 1-4 and/or Heat Transfer Compositions 1-10 and/or Blends RB1-RB20, causes the thermal management composition to vaporize.

Examples of passive recirculating systems include a heat pipe or a thermosyphon. Such systems passively recirculate the thermal management composition of the present disclosure, including each of including each of Compounds 1-4 and/or Heat Transfer Compositions 1-10 and/or Blends RB1-RB20, using gravity. In such a system, the thermal management composition is heated by the heat-generating component, resulting in a heated thermal management composition which is less dense and more buoyant. This thermal management composition travels to a storage container, such as a tank where it cools and condenses. The cooled thermal management composition then flows back to the heat source.

### Electrical Device Cooling

The present disclosure includes the use of the present compounds, including each of Compounds 1-4 and/or Heat Transfer Compositions 1-10 and/or Blends RB1-RB20 to cool and optionally heat electronic devices that produce or include a component that is a heat-generating component. The heat-generating component can be any component that includes an electronic element that generates heat as part of its operation. For the purposes of this disclosure, the heat generating component includes but is not limited to: semiconductor integrated circuits (ICs), electrochemical cells, power transistors, resistors, and electroluminescent elements, such as microprocessors, wafers used to manufacture semiconductor devices, power control semiconductors, electrical distribution switch gear, power transformers, circuit boards, multi-chip modules, packaged or unpackaged semiconductor devices, semiconductor integrated circuits, fuel cells, lasers (conventional or laser diodes), light emitting diodes (LEDs), and electrochemical cells, e.g. used for high power applications such as, for example, hybrid or electric vehicles.

For the purpose of this disclosure, the electronic device includes but is not limited to: personal computers, microprocessors, servers, cell phones, tablets, digital home appliances (e.g., televisions, media players, games consoles etc.), personal digital assistants, datacenters, batteries both stationary and in vehicles, including Li-ion batteries and other batteries used in hybrid or electric vehicles, wind turbine, train engine, or generator. Preferably the electronic device is a hybrid or electric vehicle.

The present disclosure further relates to an electronic device comprising a thermal management composition of the disclosure, including each of including each of Compounds 1-4 and/or Heat Transfer Compositions 1-10 and/or Blends RB1-RB20. For the purposes of this disclosure, the thermal management composition is provided for cooling and/or heating the electronic device.

The present disclosure further relates to an electronic device comprising a heat generating component and a thermal management composition of the disclosure, including each of including each of Compounds 1-4 and/or Heat Transfer Compositions 1-10 and/or Blends RB1-RB20, for cooling, and optionally heating, the electronic device.

The present disclosure further relates to an electronic device comprising a heat generating component, a heat exchanger, a pump and a thermal management composition of the disclosure, including each of including each of Compounds 1-4 and/or Heat Transfer Compositions 1-10 and/or Blends RB1-RB20. For the purpose of this disclosure, the electronic device can be any such device, including but not limited to personal computers, microprocessors, servers, cell phones, tablets, digital home appliances (e.g. televisions, media players, games consoles etc.), personal digital assistants, datacenters, hybrid or electric vehicles, batteries both stationary and in vehicles, electrical drive motors, fuel cells (e.g., hydrogen fuel cells) and electrical generators, preferably wherein the electronic device is in a hybrid vehicle, or electric vehicle, or wind turbine, or train.

For the purposes of this disclosure, the heat generating component can be any electrical component that generates heat during operation, but preferably electronic components that generate heat at high levels of heat flux. Examples of heat generating components that can be cooled according to the present disclosure include semiconductor integrated circuits (ICs), electrochemical cells, power transistors, resistors, and electroluminescent elements, such as microprocessors, wafers used to manufacture semiconductor devices, power control semiconductors, electrical distribution switch gear, power transformers, printed circuit boards (PCBs), multi-chip modules, packaged or unpackaged semiconductor devices, semiconductor integrated circuits, fuel cells, lasers (conventional or laser diodes), light emitting diodes (LEDs), and electrochemical cells, e.g. used for high power applications such as, for example, hybrid or electric vehicles.

### Lithium-Ion Battery Cooling Systems

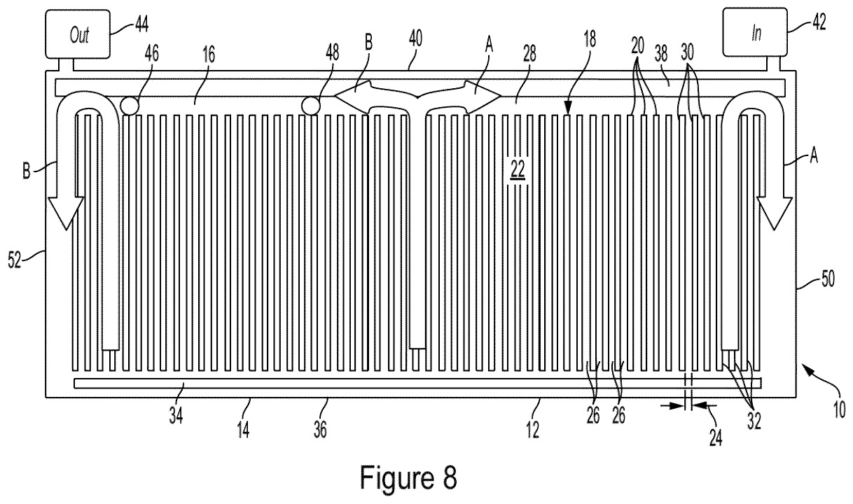

Examples of the present thermal management methods useful for lithium-ion battery cooling, including Heat Transfer Methods 1 and 2 and Thermal Management Methods 1-2, will now be described in connection with FIG. 8. A vehicle battery pack with a self-contained liquid cooling system 10 comprising a module 12 formed of a container 14 with an interior space 16 for supporting a battery assembly 18. The container 14 is a closed and sealed container 14 for forming a self-contained liquid cooling system 10. The battery assembly 18 includes a plurality of battery cells 20 such as a plurality of Lithium-ion (Li-ion) batteries for use in a hybrid vehicle. In another embodiment, the plurality of battery cells 20 is Li-ion batteries for use in a Battery Electric Vehicle (BEV). Additional batteries for use with other prime mover vehicles may be provided with the liquid cooling system 10 of the present disclosure, where each battery cell includes active material for generating power from an electrochemical reaction within the interior space 16 of the container 14. The battery cells 20 are preferably stacked to form a battery cell stack 22. In the embodiment shown, a gap 24 between each battery cell 20 is between 0.25-0.50 mm, forming a fluid channel 26 between each battery cell 20. In another embodiment, the gap 24 may be less than 0.25 mm. It is understood that other gap sizes can be used as desired.

A composition of the present disclosure, including each of Compounds 1-4 and/or Heat Transfer Compositions 1-10 and/or Blends RB1-RB20 is disposed within the interior space 16 of the container 14 and the fluid level shown is such that the battery assembly 18 is completely immersed within the composition of the present disclosure. The composition of the present disclosure, including each of Compounds 1-4 and/or Heat Transfer Compositions 1-10 and/or Blends RB1-RB20 is in contact with the battery cells 20 through the fluid channels 26 formed by gaps 24.

A heating element 34 is located at a base area 36 of the container 14. The heating element 34 shown is an electronic heating element. It is understood that other heating element types may be used. The heating element 34 is shown as a single element; however, multiple heating elements 34 such as heating plates may be provided.

A cooling element 38 is located at an upper area 40 of the container 14. The cooling element 38 may be a chilled water condenser having an inlet 42 and an outlet 44 extending beyond the walls of the sealed container 14 for importing and exporting water for the cooling element 38. In another embodiment, the cooling element 38 may be a chilled water plate. In still another embodiment, the cooling element 38 may be a thin aluminum heat sink having external chilled water travelling through the cooling element 38. The cooling element 38 may be a graphite foil impregnated with an electrically nonconductive polymer. The cooling element may also be formed from copper.

In the embodiment shown, arrows “A” and “B” indicate a flow 28 of the composition of the present disclosure, including each of including each of Compounds 1-4 and/or Heat Transfer Compositions 1-10 and/or Blends RB1-RB20, and each of the heat transfer compositions. Upon heating of each battery cell 20 by the heating element 34, the coolant 28 of the present disclosure, including each of Compounds 1-4 and/or Heat Transfer Compositions 1-10 and/or Blends RB1-RB20, is exposed to a front surface area 30 and a rear surface area 32 of the battery cells 20, and will boil. The heated coolant 28 will rise and flow to the top of the battery cell stack 22 to be cooled by the cooling element 38. The cooled coolant 28 will return to the base area 36, generally following either coolant paths “A” or “B.” Where the general location of the coolant 28 at the moment of boiling is located within the fluid channels 26 of the battery cells 20 in the center area and toward a side 50 of the container 14, the coolant 28 will tend to follow flow path “A”. Similarly, if the general location of the dielectric coolant 28 at the moment of boiling is located within the fluid channels 26 of the battery cells 20 in the center area and toward an opposing side 52 of the container 14, the dielectric coolant 28 will tend to follow flow path “B”.

A coolant temperature sensor 46 is located on or near the cooling element 38. In the embodiment shown, the temperature sensor 46 is located within the area of the outlet 44 of the cooling element 38 and measures a temperature of the dielectric coolant 28 of the present disclosure at a point of exposure to the cooling element. The temperature sensor 46 may be located anywhere within the battery cell stack 22 as desired.

A coolant level sensor 48 is also provided and is located near the upper area 40 of the container 14 to measure the fluid level of the dielectric coolant 28 within the container 14, ensuring complete immersion of the battery assembly 18 within the dielectric coolant 28.

### Heat Pipe Cooling and Heating

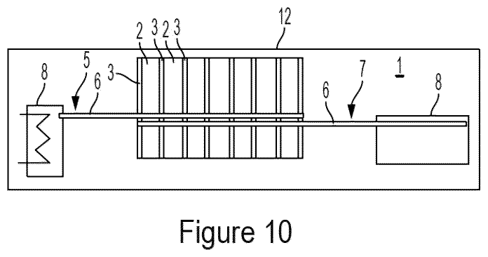

An example of the present heat transfer methods using a heat pipe is now described with respect to FIG. 10, which is a specific example of a heat pipe in an energy storage assembly 1 according to one exemplary embodiment of the disclosure. The energy storage assembly 1 may be part of a motor vehicle 12, in particular of a hybrid or electric vehicle, and is provided to supply electric power to electric consumers, like e.g., an electrical drive unit (not shown), on the motor vehicle side. The energy storage assembly 1 includes a plurality of electrical energy stores. 2. The electrical energy stores 2 are electrically connected via an electric connection element (not shown), in particular in the form of a conductive rail or conductor rail (“bus bar”), i.e., connected in series or in parallel. The electric connection element contacts hereby corresponding electrical connectors (not shown) arranged on respective exposed outer wall sections of corresponding energy storage housings (not shown) of the energy stores 2 in parallel alignment arranged adjacent to one another to thereby form an energy store stack (“stack”). Plate-shaped spacer elements 3 are respectively arranged between the energy stores 2 to separate them and at the same time thermally conductive properties. The spacer elements 3 thus provide, on one hand, spacing between immediately adjacent energy stores 2 so that immediately adjacent energy stores 2 do not contact each other electrically or mechanically. On the other hand, the spacer elements 3 act as a result of their thermally conductive properties as heat conductors for the purpose of cooling the energy stores 2 or the energy storage assembly 1 by dissipating heat, particularly from the contacting energy stores 2, or, for the purpose of heating the energy stores 2 or energy storage assembly 1 by supplying heat, particularly to the contacting energy stores 2. A heat pipe 4 of a first heat pipe assembly 5 and of a heat pipe 6 of a second heat pipe assembly 7 are provide. The heat pipes 4, 6 thus extend along this side surface of the energy store stack and are thermally coupled to the spacer elements 3, respectively. The spacer elements 3 thus form a thermal bridge between the heat pipes 4 of the first heat pipe assembly 5 and the heat pipes 6 of the second heat pipe assembly 7, on one hand, and the energy stores 2, on the other hand. The respective heat pipes 4 of the first heat pipe assembly 5 are arranged and aligned such as to be thermally coupled with respective evaporation zones, in which a contained thermal management composition of the present disclosure, including particularly each of Compounds 1-4 and/or Heat Transfer Compositions 1-10 and/or Blends RB1-RB20, can be evaporated, to the spacer elements 3. Heat (evaporation heat) required for the evaporation of the present TMC is thus removed from the spacer elements 3 or via the spacer elements 3 from the energy stores 2. The energy stores 2, including the energy storage assembly 1, can thus be cooled via the heat pipes 4 of the first heat pipe assembly 5. Also, the respective condensation zones of the heat pipes 4 of the first heat pipe assembly 5, in which condensation zones a contained gaseous thermal management composition of the present disclosure, including particularly each of Compounds 1-4 and/or Heat Transfer Compositions 1-10 and/or Blends RB1-RB20 can be condensed, are thermally coupled with a heat sink 8 in the form of a motor-vehicle-side heat exchanger. Heat (condensation heat) generated during condensation of the present TMC can thus be transferred to the heat sink 8. The heat exchanger can be part of the energy storage assembly 1, i.e., belong to or associated with the energy storage assembly 1. The respective heat pipes 6 of the second heat pipe assembly 7 are arranged and aligned such as to be thermally coupled with their respective condensation zones, in which the contained gaseous TMC of the present disclosure can be condensed, to the spacer elements 3. Heat (condensation heat) can thus be transferred during condensation of the present TMC to the spacer elements 3 or via the spacer elements 3 to the energy stores 2. Thus, the energy stores 2 and the energy storage assembly 1, can be heated via the heat pipes 6 of the second heat pipe assembly 7. Also, the respective evaporation zones of the heat pipes 6 of the second heat pipe assembly 7, in which evaporation zones a contained TMC of the present disclosure can be evaporated, are thermally coupled with a heat source 9 in the form of a functional component, i.e., e.g., a charger or a control device or a control electronics, associated to the energy storage assembly 1. Heat (evaporation heat) required for the evaporation of the TMC can thus be removed from the heat source 9. Thus, the functional component can be cooled via the heat pipes 6 of the second heat pipe assembly 7. The two heat pipe assemblies 5, 7, and their associated heat pipes 4, 6 enables implementation of a temperature control device for controlling the temperature, i.e., for heating or cooling, of the energy stores 2 of the energy storage assembly 1. The heat pipes useful according to the present disclosure include both gravity return heat pipe, capillary return heat pipe and gravity/capillary return heat pipes.

The table below defines some preferred uses of the present compounds, and methods of using the present compounds, including in connection with the Examples herein. The first column of the table below identifies and defines the use as Use1, Use2, etc., and in column 2 one or more of the refrigerants (Ref.) as identified above as Compounds 1-4 and/or Thermal Transfer Compositions 1-7 and/or Blends RB1-RB20 using the abbreviations TMC 1, TMC 2, etc. The device or articles are as specified, with “EV Battery” meaning electric vehicle battery and “IC” meaning integrated circuit. The designation “NR” is understood to mean that the component or property is not required (but may be present) by the use defined in each particular row of the table.

TABLE 4
Exemplary Uses

| | | | | | Operating |
|---|---|---|---|---|---|
| | | | | Device or | Temperature Range |
| | | | | article being | of Device or Article |
| Use | | | Heat Transfer | heated and/ | being Heated or |
| No. | TMC | Type of Use | Type | or cooled | Cooled, ° C. |
| Use | 1 | Thermal | single phase | Battery | NR |
| 1A1 | | Management | | | |
| | | Immersion | | | |
| Use | 1 | Thermal | phase change | Battery | NR |
| 1A2 | | Management | | | |
| | | Immersion | | | |
| Use | 1 | Thermal | single phase | Battery | NR |
| 1A3 | | Management | and phase | | |
| | | Immersion | change | | |
| Use | 1 | Thermal | single phase | Battery | −40° C.-80° C. |
| 1B1 | | Management | | | |
| | | Immersion | | | |
| Use | 1 | Thermal | phase change | Battery | −40° C.-80° C. |
| 1B2 | | Management | | | |
| | | Immersion | | | |
| Use | 1 | Thermal | single phase | Battery | −40° C.-80° C. |
| 1B3 | | Management | and phase | | |
| | | Immersion | change | | |
| Use | 1 | Thermal | single phase | EV Battery | NR |
| 1C1 | | Management | | | |
| | | Immersion | | | |
| Use | 1 | Thermal | phase change | EV Battery | NR |
| 1C2 | | Management | | | |
| | | Immersion | | | |
| Use | 1 | Thermal | single phase | EV Battery | NR |
| 1C3 | | Management | and phase | | |
| | | Immersion | change | | |
| Use | 1 | Thermal | single phase | EV Battery | −40° C.-80° C. |
| 1D1 | | Management | | | |
| | | Immersion | | | |
| Use | 1 | Thermal | phase change | EV Battery | −40° C.-80° C. |
| 1D2 | | Management | | | |
| | | Immersion | | | |
| Use | 1 | Thermal | single phase | EV Battery | −40° C.-80° C. |
| 1D3 | | Management | and phase | | |
| | | Immersion | change | | |
| Use | 1 | Thermal | single phase | Data Center | NR |
| 1E1 | | Management | | Server | |
| | | Immersion | | | |
| 1E2 | 1 | Thermal | phase change | Data Center | NR |
| | | Management | | Server | |
| | | Immersion | | | |
| 1E3 | 1 | Thermal | single phase | Data Center | NR |
| | | Management | and phase | Server | |
| | | Immersion | change | | |
| Use | 1 | Thermal | single phase | Data Center | 30° C.-80° C. |
| 1F1 | | Management | | Server | |
| | | Immersion | | | |
| Use | 1 | Thermal | phase change | Data Center | 30° C.-80° C. |
| 1F2 | | Management | | Server | |
| | | Immersion | | | |
| Use | 1 | Thermal | single phase | Data Center | 30° C.-80° C. |
| 1F3 | | Management | and phase | Server | |
| | | Immersion | change | | |
| Use | 1 | Thermal | single phase | ICs | NR |
| 1G1 | | Management | | | |
| | | Immersion | | | |
| Use | 1 | Thermal | phase change | ICs | NR |
| 1G2 | | Management | | | |
| | | Immersion | | | |
| Use | 1 | Thermal | single phase | ICs | NR |
| 1G3 | | Management | and phase | | |
| | | Immersion | change | | |
| Use | 1 | Thermal | single phase | ICs | 30° C.-80° C. |
| 1H1 | | Management | | | |
| | | Immersion | | | |
| Use | 1 | Thermal | phase change | ICs | 30° C.-80° C. |
| 1H2 | | Management | | | |
| | | Immersion | | | |
| Use | 1 | Thermal | single phase | ICs | 30° C.-80° C. |
| 1H3 | | Management | and phase | | |
| | | Immersion | change | | |
| Use | 2 | Thermal | single phase | Battery | NR |
| 2A1 | | Management | | | |
| | | Immersion | | | |
| Use | 2 | Thermal | phase change | Battery | NR |
| 2A2 | | Management | | | |
| | | Immersion | | | |
| Use | 2 | Thermal | single phase | Battery | NR |
| 2A3 | | Management | and phase | | |
| | | Immersion | change | | |
| Use | 2 | Thermal | single phase | Battery | −40° C.-80° C. |
| 2B1 | | Management | | | |
| | | Immersion | | | |
| Use | 2 | Thermal | phase change | Battery | −40° C.-80° C. |
| 2B2 | | Management | | | |
| | | Immersion | | | |
| Use | 2 | Thermal | single phase | Battery | −40° C.-80° C. |
| 2B3 | | Management | and phase | | |
| | | Immersion | change | | |
| Use | 2 | Thermal | single phase | EV Battery | NR |
| 2C1 | | Management | | | |
| | | Immersion | | | |
| Use | 2 | Thermal | phase change | EV Battery | NR |
| 2C2 | | Management | | | |
| | | Immersion | | | |
| Use | 2 | Thermal | single phase | EV Battery | NR |
| 2C3 | | Management | and phase | | |
| | | Immersion | change | | |
| Use | 2 | Thermal | single phase | EV Battery | −40° C.-80° C. |
| 2D1 | | Management | | | |
| | | Immersion | | | |
| Use | 2 | Thermal | phase change | EV Battery | −40° C.-80° C. |
| 2D2 | | Management | | | |
| | | Immersion | | | |
| Use | 2 | Thermal | single phase | EV Battery | −40° C.-80° C. |
| 2D3 | | Management | and phase | | |
| | | Immersion | change | | |
| Use | 2 | Thermal | single phase | Data Center | NR |
| 2E1 | | Management | | Server | |
| | | Immersion | | | |
| Use | 2 | Thermal | phase change | Data Center | NR |
| 2E2 | | Management | | Server | |
| | | Immersion | | | |
| Use | 2 | Thermal | single phase | Data Center | NR |
| 2E3 | | Management | and phase | Server | |
| | | Immersion | change | | |
| Use | 2 | Thermal | single phase | Data Center | 30° C.-80° C. |
| 2F1 | | Management | | Server | |
| | | Immersion | | | |
| Use | 2 | Thermal | phase change | Data Center | 30° C.-80° C. |
| 2F2 | | Management | | Server | |
| | | Immersion | | | |
| Use | 2 | Thermal | single phase | Data Center | 30° C.-80° C. |
| 2F3 | | Management | and phase | Server | |
| | | Immersion | change | | |
| Use | 2 | Thermal | single phase | ICs | NR |
| 2G1 | | Management | | | |
| | | Immersion | | | |
| Use | 2 | Thermal | phase change | ICs | NR |
| 2G2 | | Management | | | |
| | | Immersion | | | |
| Use | 2 | Thermal | single phase | ICs | NR |
| 2G3 | | Management | and phase | | |
| | | Immersion | change | | |
| Use | 2 | Thermal | single phase | ICs | 30° C.-80° C. |
| 2H1 | | Management | | | |
| | | Immersion | | | |
| Use | 2 | Thermal | phase change | ICs | 30° C.-80° C. |
| 2H2 | | Management | | | |
| | | Immersion | | | |
| Use | 2 | Thermal | single phase | ICs | 30° C.-80° C. |
| 2H3 | | Management | and phase | | |
| | | Immersion | change | | |
| Use | 3 | Thermal | single phase | Battery | NR |
| 3A1 | | Management | | | |
| | | Immersion | | | |
| Use | 3 | Thermal | phase change | Battery | NR |
| 3A2 | | Management | | | |
| | | Immersion | | | |
| Use | 3 | Thermal | single phase | Battery | NR |
| 3A3 | | Management | and phase | | |
| | | Immersion | change | | |
| Use | 3 | Thermal | single phase | Battery | −40° C.-80° C. |
| 3B1 | | Management | | | |
| | | Immersion | | | |
| Use | 3 | Thermal | phase change | Battery | −40° C.-80° C. |
| 3B2 | | Management | | | |
| | | Immersion | | | |
| Use | 3 | Thermal | single phase | Battery | −40° C.-80° C. |
| 3B3 | | Management | and phase | | |
| | | Immersion | change | | |
| Use | 3 | Thermal | single phase | EV Battery | NR |
| 3C1 | | Management | | | |
| | | Immersion | | | |
| Use | 3 | Thermal | phase change | EV Battery | NR |
| 3C2 | | Management | | | |
| | | Immersion | | | |
| Use | 3 | Thermal | single phase | EV Battery | NR |
| 3C3 | | Management | and phase | | |
| | | Immersion | change | | |
| Use | 3 | Thermal | single phase | EV Battery | −40° C.-80° C. |
| 3D1 | | Management | | | |
| | | Immersion | | | |
| Use | 3 | Thermal | phase change | EV Battery | −40° C.-80° C. |
| 3D2 | | Management | | | |
| | | Immersion | | | |
| Use | 3 | Thermal | single phase | EV Battery | −40° C.-80° C. |
| 3D3 | | Management | and phase | | |
| | | Immersion | change | | |
| Use | 3 | Thermal | single phase | Data Center | NR |
| 3E1 | | Management | | Server | |
| | | Immersion | | | |
| Use | 3 | Thermal | phase change | Data Center | NR |
| 3E2 | | Management | | Server | |
| | | Immersion | | | |
| Use | 3 | Thermal | single phase | Data Center | NR |
| 3E3 | | Management | and phase | Server | |
| | | Immersion | change | | |
| Use | 3 | Thermal | single phase | Data Center | 30° C.-80° C. |
| 3F1 | | Management | | Server | |
| | | Immersion | | | |
| Use | 3 | Thermal | phase change | Data Center | 30° C.-80° C. |
| 3F2 | | Management | | Server | |
| | | Immersion | | | |
| Use | 3 | Thermal | single phase | Data Center | 30° C.-80° C. |
| 3F3 | | Management | and phase | Server | |
| | | Immersion | change | | |
| Use | 3 | Thermal | single phase | ICs | NR |
| 3G1 | | Management | | | |
| | | Immersion | | | |
| Use | 3 | Thermal | phase change | ICs | NR |
| 3G2 | | Management | | | |
| | | Immersion | | | |
| Use | 3 | Thermal | single phase | ICs | NR |
| 3G3 | | Management | and phase | | |
| | | Immersion | change | | |
| Use | 3 | Thermal | single phase | ICs | 30° C.-80° C. |
| 3H1 | | Management | | | |
| | | Immersion | | | |
| Use | 3 | Thermal | phase change | ICs | 30° C.-80° C. |
| 3H2 | | Management | | | |
| | | Immersion | | | |
| Use | 3 | Thermal | single phase | ICs | 30° C.-80° C. |
| 3H3 | | Management | and phase | | |
| | | Immersion | change | | |
| Use | 4 | Thermal | single phase | Battery | NR |
| 4A1 | | Management | | | |
| | | Immersion | | | |
| Use | 4 | Thermal | phase change | Battery | NR |
| 4A2 | | Management | | | |
| | | Immersion | | | |
| Use | 4 | Thermal | single phase | Battery | NR |
| 4A3 | | Management | and phase | | |
| | | Immersion | change | | |
| Use | 4 | Thermal | single phase | Battery | −40° C.-80° C. |
| 4B1 | | Management | | | |
| | | Immersion | | | |
| Use | 4 | Thermal | phase change | Battery | −40° C.-80° C. |
| 4B2 | | Management | | | |
| | | Immersion | | | |
| Use | 4 | Thermal | single phase | Battery | −40° C.-80° C. |
| 4B3 | | Management | and phase | | |
| | | Immersion | change | | |
| Use | 4 | Thermal | single phase | EV Battery | NR |
| 4C1 | | Management | | | |
| | | Immersion | | | |
| Use | 4 | Thermal | phase change | EV Battery | NR |
| 4C2 | | Management | | | |
| | | Immersion | | | |
| Use | 4 | Thermal | single phase | EV Battery | NR |
| 4C3 | | Management | and phase | | |
| | | Immersion | change | | |
| Use | 4 | Thermal | single phase | EV Battery | −40° C.-80° C. |
| 4D1 | | Management | | | |
| | | Immersion | | | |
| Use | 4 | Thermal | phase change | EV Battery | −40° C.-80° C. |
| 4D2 | | Management | | | |
| | | Immersion | | | |
| Use | 4 | Thermal | single phase | EV Battery | −40° C.-80° C. |
| 4D3 | | Management | and phase | | |
| | | Immersion | change | | |
| Use | 4 | Thermal | single phase | Data Center | NR |
| 4E1 | | Management | | Server | |
| | | Immersion | | | |
| Use | 4 | Thermal | phase change | Data Center | NR |
| 4E2 | | Management | | Server | |
| | | Immersion | | | |
| Use | 4 | Thermal | single phase | Data Center | NR |
| 4E3 | | Management | and phase | Server | |
| | | Immersion | change | | |
| Use | 4 | Thermal | single phase | Data Center | 30° C.-80° C. |
| 4F1 | | Management | | Server | |
| | | Immersion | | | |
| Use | 4 | Thermal | phase change | Data Center | 30° C.-80° C. |
| 4F2 | | Management | | Server | |
| | | Immersion | | | |
| Use | 4 | Thermal | single phase | Data Center | 30° C.-80° C. |
| 4F3 | | Management | and phase | Server | |
| | | Immersion | change | | |
| Use | 4 | Thermal | single phase | ICs | NR |
| 4G1 | | Management | | | |
| | | Immersion | | | |
| Use | 4 | Thermal | phase change | ICs | NR |
| 4G2 | | Management | | | |
| | | Immersion | | | |
| Use | 4 | Thermal | single phase | ICs | NR |
| 4G3 | | Management | and phase | | |
| | | Immersion | change | | |
| Use | 4 | Thermal | single phase | ICs | 30° C.-80° C. |
| 4H1 | | Management | | | |
| | | Immersion | | | |
| Use | 4 | Thermal | phase change | ICs | 30° C.-80° C. |
| 4H2 | | Management | | | |
| | | Immersion | | | |
| Use | 4 | Thermal | single phase | ICs | 30° C.-80° C. |
| 4H3 | | Management | and phase | | |
| | | Immersion | change | | |
| Use | 5 | Thermal | single phase | Battery | NR |
| 5A1 | | Management | | | |
| | | Immersion | | | |
| Use | 5 | Thermal | phase change | Battery | NR |
| 5A2 | | Management | | | |
| | | Immersion | | | |
| Use | 5 | Thermal | single phase | Battery | NR |
| 5A3 | | Management | and phase | | |
| | | Immersion | change | | |
| Use | 5 | Thermal | single phase | Battery | −40° C.-80° C. |
| 5B1 | | Management | | | |
| | | Immersion | | | |
| Use | 5 | Thermal | phase change | Battery | −40° C.-80° C. |
| 5B2 | | Management | | | |
| | | Immersion | | | |
| Use | 5 | Thermal | single phase | Battery | −40° C.-80° C. |
| 5B3 | | Management | and phase | | |
| | | Immersion | change | | |
| Use | 5 | Thermal | single phase | EV Battery | NR |
| 5C1 | | Management | | | |
| | | Immersion | | | |
| Use | 5 | Thermal | phase change | EV Battery | NR |
| 5C2 | | Management | | | |
| | | Immersion | | | |
| Use | 5 | Thermal | single phase | EV Battery | NR |
| 5C3 | | Management | and phase | | |
| | | Immersion | change | | |
| Use | 5 | Thermal | single phase | EV Battery | −40° C.-80° C. |
| 5D1 | | Management | | | |
| | | Immersion | | | |
| Use | 5 | Thermal | phase change | EV Battery | −40° C.-80° C. |
| 5D2 | | Management | | | |
| | | Immersion | | | |
| Use | 5 | Thermal | single phase | EV Battery | −40° C.-80° C. |
| 5D3 | | Management | and phase | | |
| | | Immersion | change | | |
| Use | 5 | Thermal | single phase | Data Center | NR |
| 5E1 | | Management | | Server | |
| | | Immersion | | | |
| Use | 5 | Thermal | phase change | Data Center | NR |
| 5E2 | | Management | | Server | |
| | | Immersion | | | |
| Use | 5 | Thermal | single phase | Data Center | NR |
| 5E3 | | Management | and phase | Server | |
| | | Immersion | change | | |
| Use | 5 | Thermal | single phase | Data Center | 30° C.-80° C. |
| 5F1 | | Management | | Server | |
| | | Immersion | | | |
| Use | 5 | Thermal | phase change | Data Center | 30° C.-80° C. |
| 5F2 | | Management | | Server | |
| | | Immersion | | | |
| Use | 5 | Thermal | single phase | Data Center | 30° C.-80° C. |
| 5F3 | | Management | and phase | Server | |
| | | Immersion | change | | |
| Use | 5 | Thermal | single phase | ICs | NR |
| 5G1 | | Management | | | |
| | | Immersion | | | |
| Use | 5 | Thermal | phase change | ICs | NR |
| 5G2 | | Management | | | |
| | | Immersion | | | |
| Use | 5 | Thermal | single phase | ICs | NR |
| 5G3 | | Management | and phase | | |
| | | Immersion | change | | |
| Use | 5 | Thermal | single phase | ICs | 30° C.-80° C. |
| 5H1 | | Management | | | |
| | | Immersion | | | |
| Use | 5 | Thermal | phase change | ICs | 30° C.-80° C. |
| 5H2 | | Management | | | |
| | | Immersion | | | |
| Use | 5 | Thermal | single phase | ICs | 30° C.-80° C. |
| 5H3 | | Management | and phase | | |
| | | Immersion | change | | |
| Use | 6 | Thermal | single phase | Battery | NR |
| 6A1 | | Management | | | |
| | | Immersion | | | |
| Use | 6 | Thermal | phase change | Battery | NR |
| 6A2 | | Management | | | |
| | | Immersion | | | |
| Use | 6 | Thermal | single phase | Battery | NR |
| 6A3 | | Management | and phase | | |
| | | Immersion | change | | |
| Use | 6 | Thermal | single phase | Battery | −40° C.-80° C. |
| 6B1 | | Management | | | |
| | | Immersion | | | |
| Use | 6 | Thermal | phase change | Battery | −40° C.-80° C. |
| 6B2 | | Management | | | |
| | | Immersion | | | |
| Use | 6 | Thermal | single phase | Battery | −40° C.-80° C. |
| 6B3 | | Management | and phase | | |
| | | Immersion | change | | |
| Use | 6 | Thermal | single phase | EV Battery | NR |
| 6C1 | | Management | | | |
| | | Immersion | | | |
| Use | 6 | Thermal | phase change | EV Battery | NR |
| 6C2 | | Management | | | |
| | | Immersion | | | |
| Use | 6 | Thermal | single phase | EV Battery | NR |
| 6C3 | | Management | and phase | | |
| | | Immersion | change | | |
| Use | 6 | Thermal | single phase | EV Battery | −40° C.-80° C. |
| 6D1 | | Management | | | |
| | | Immersion | | | |
| Use | 6 | Thermal | phase change | EV Battery | −40° C.-80° C. |
| 6D2 | | Management | | | |
| | | Immersion | | | |
| Use | 6 | Thermal | single phase | EV Battery | −40° C.-80° C. |
| 6D3 | | Management | and phase | | |
| | | Immersion | change | | |
| Use | 6 | Thermal | single phase | Data Center | NR |
| 6E1 | | Management | | Server | |
| | | Immersion | | | |
| Use | 6 | Thermal | phase change | Data Center | NR |
| 6E2 | | Management | | Server | |
| | | Immersion | | | |
| Use | 6 | Thermal | single phase | Data Center | NR |
| 6E3 | | Management | and phase | Server | |
| | | Immersion | change | | |
| Use | 6 | Thermal | single phase | Data Center | 30° C.-80° C. |
| 6F1 | | Management | | Server | |
| | | Immersion | | | |
| Use | 6 | Thermal | phase change | Data Center | 30° C.-80° C. |
| 6F2 | | Management | | Server | |
| | | Immersion | | | |
| Use | 6 | Thermal | single phase | Data Center | 30° C.-80° C. |
| 6F3 | | Management | and phase | Server | |
| | | Immersion | change | | |
| Use | 6 | Thermal | single phase | ICs | NR |
| 6G1 | | Management | | | |
| | | Immersion | | | |
| Use | 6 | Thermal | phase change | ICs | NR |
| 6G2 | | Management | | | |
| | | Immersion | | | |
| Use | 6 | Thermal | single phase | ICs | NR |
| 6G3 | | Management | and phase | | |
| | | Immersion | change | | |
| Use | 6 | Thermal | single phase | ICs | 30° C.-80° C. |
| 6H1 | | Management | | | |
| | | Immersion | | | |
| Use | 6 | Thermal | phase change | ICs | 30° C.-80° C. |
| 6H2 | | Management | | | |
| | | Immersion | | | |
| Use | 6 | Thermal | single phase | ICs | 30° C.-80° C. |
| 6H3 | | Management | and phase | | |
| | | Immersion | change | | |
| Use | 7 | Thermal | single phase | Battery | NR |
| 7A1 | | Management | | | |
| | | Immersion | | | |
| Use | 7 | Thermal | phase change | Battery | NR |
| 7A2 | | Management | | | |
| | | Immersion | | | |
| Use | 7 | Thermal | single phase | Battery | NR |
| 7A3 | | Management | and phase | | |
| | | Immersion | change | | |
| Use | 7 | Thermal | single phase | Battery | −40° C.-80° C. |
| 7B1 | | Management | | | |
| | | Immersion | | | |
| Use | 7 | Thermal | phase change | Battery | −40° C.-80° C. |
| 7B2 | | Management | | | |
| | | Immersion | | | |
| Use | 7 | Thermal | single phase | Battery | −40° C.-80° C. |
| 7B3 | | Management | and phase | | |
| | | Immersion | change | | |
| Use | 7 | Thermal | single phase | EV Battery | NR |
| 7C1 | | Management | | | |
| | | Immersion | | | |
| Use | 7 | Thermal | phase change | EV Battery | NR |
| 7C2 | | Management | | | |
| | | Immersion | | | |
| Use | 7 | Thermal | single phase | EV Battery | NR |
| 7C3 | | Management | and phase | | |
| | | Immersion | change | | |
| Use | 7 | Thermal | single phase | EV Battery | −40° C.-80° C. |
| 7D1 | | Management | | | |
| | | Immersion | | | |
| Use | 7 | Thermal | phase change | EV Battery | −40° C.-80° C. |
| 7D2 | | Management | | | |
| | | Immersion | | | |
| Use | 7 | Thermal | single phase | EV Battery | −40° C.-80° C. |
| 7D3 | | Management | and phase | | |
| | | Immersion | change | | |
| Use | 7 | Thermal | single phase | Data Center | NR |
| 7E1 | | Management | | Server | |
| | | Immersion | | | |
| Use | 7 | Thermal | phase change | Data Center | NR |
| 7E2 | | Management | | Server | |
| | | Immersion | | | |
| Use | 7 | Thermal | single phase | Data Center | NR |
| 7E3 | | Management | and phase | Server | |
| | | Immersion | change | | |
| Use | 7 | Thermal | single phase | Data Center | 30° C.-80° C. |
| 7F1 | | Management | | Server | |
| | | Immersion | | | |
| Use | 7 | Thermal | phase change | Data Center | 30° C.-80° C. |
| 7F2 | | Management | | Server | |
| | | Immersion | | | |
| Use | 7 | Thermal | single phase | Data Center | 30° C.-80° C. |
| 7F3 | | Management | and phase | Server | |
| | | Immersion | change | | |
| Use | 7 | Thermal | single phase | ICs | NR |
| 7G1 | | Management | | | |
| | | Immersion | | | |
| Use | 7 | Thermal | phase change | ICs | NR |
| 7G2 | | Management | | | |
| | | Immersion | | | |
| Use | 7 | Thermal | single phase | ICs | NR |
| 7G3 | | Management | and phase | | |
| | | Immersion | change | | |
| Use | 7 | Thermal | single phase | ICs | 30° C.-80° C. |
| 7H1 | | Management | | | |
| | | Immersion | | | |
| Use | 7 | Thermal | phase change | ICs | 30° C.-80° C. |
| 7H2 | | Management | | | |
| | | Immersion | | | |
| Use | 7 | Thermal | single phase | ICs | 30° C.-80° C. |
| 7H3 | | Management | and phase | | |
| | | Immersion | change | | |

### Organic Rankine Cycles

When a heat transfer fluid of the present disclosure, including Compounds 1-4 and/or Heat Transfer Compositions 1-10 and/or Blends RB1-RB20, is used in an Organic Rankine cycle, it may be referred to as a working fluid.

The working fluid therefore corresponds to the heat transfer fluid as discussed in this application. All preferred features of the heat transfer fluid apply to the working fluid as described herein.

Rankine cycle systems are known to be a simple and reliable means to convert heat energy into mechanical energy in the form of shaft power. In industrial settings, it may be possible to use flammable working fluids such as toluene and pentane, particularly when the industrial setting has large quantities of flammables already on site in processes or storage. However, for instances where the risk associated with use of a flammable and/or toxic working fluid is not acceptable, such as power generation in populous areas or near buildings, it is necessary or at least highly desirable to use non-flammable and/or non-toxic refrigerants as the working fluid. There is also a drive in the industry for these materials to be environmentally acceptable in terms of GWP.

The process for recovering waste heat in an Organic Rankine cycle according to the present disclosure preferably involves pumping liquid-phase working fluids of the present disclosure, including each of Compounds 1-4 and/or Heat Transfer Compositions 1-10 and/or Blends RB1-RB20, through a boiler where an external (waste) heat source, such as a process stream, heats the working fluid causing it to evaporate into a saturated or superheated vapor. This vapor is expanded through a turbine wherein the waste heat energy is converted into mechanical energy. Subsequently, the vapor phase working fluid is condensed to a liquid and pumped back to the boiler in order to repeat the heat extraction cycle.

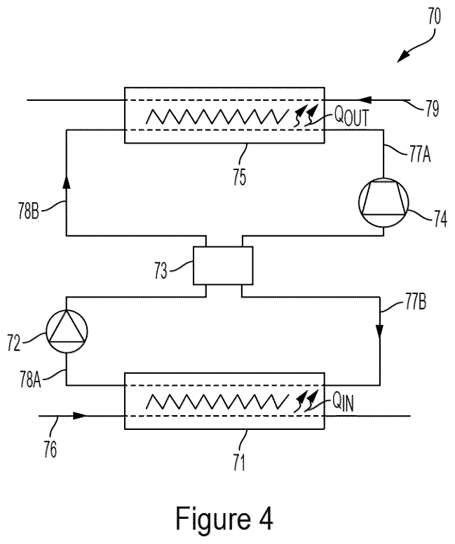

Referring to FIG. 4, in an exemplary organic Rankine cycle system 70, working fluid of the present disclosure, including each of Compounds 1-4 and/or Heat Transfer Compositions 1-10 and/or Blends RB1-RB20, is circulated between an evaporator 71 and a condenser 75, with a pump 72 and an expansion device 74 functionally disposed therebetween. In the illustrated embodiment, an external flow of fluid is directed to evaporator 71 via external warm conduit 76. External warm conduit 76 may carry fluid from a warm heat source, such as a waste heat source from industrial processes (e.g., power generation), flue gases, exhaust gases, geothermal sources, etc.

Evaporator 71 is preferably configured as a heat exchanger which may include, e.g., a series of thermally connected, but fluidly isolated, tubes carrying fluid from warm conduit 76 and fluid from working fluid conduit 77B respectively. Thus, evaporator 71 facilitates the transfer of heat QIN from the warm fluid arriving from external warm conduit 76 to the relatively cooler (e.g., “cold”) working fluid arriving from expansion device 74 via working fluid conduit 77B.

The working fluid of the present disclosure, including each of Compounds 1-4 and/or Heat Transfer Compositions 1-10 and/or Blends RB1-RB20, thus exits from evaporator 71, having been warmed by the absorption of heat QIN, and then travels through working fluid conduit 78A to pump 72. Pump 72 pressurizes the working fluid, thereby further warming the fluid through external energy inputs (e.g., electricity). The resulting “hot” fluid passes to an input of condenser 75 via conduit 78B, optionally via a regenerator 73 as described below.

Condenser 75 is configured as a heat exchanger similar to evaporator 71, and may include, e.g., a series of thermally connected, but fluidly isolated, tubes carrying fluid from cool conduit 79 and fluid from working fluid conduit 78B respectively. Condenser 75 facilitates the transfer of heat QOUT to the cool fluid arriving from external cool conduit 79 to the relatively warmer (e.g., “hot”) working fluid of the present disclosure, including each of Compounds 1-4, arriving from pump 72 via working fluid conduit 78B.

The working fluid of the present disclosure, Compounds 1-4 and/or Heat Transfer Compositions 1-10 and/or Blends RB1-RB20, exiting from condenser 75, having thus been cooled by the loss of heat QOUT, then travels through working fluid conduit 77A to expansion device 74. Expansion device 74 allows the working fluid to expand, thereby further cooling the fluid. At this stage, the fluid of the present disclosure, including each of Compounds 1-4 and/or Heat Transfer Compositions 1-10 and/or Blends RB1-RB20, may perform work, e.g., by driving a turbine. The resulting “cold” fluid passes to an input of evaporator 71 via conduit 77B, optionally via a regenerator 73 as described below, and the cycle begins anew.

Thus, working fluid conduits 77A, 77B, 78A and 78B define a closed loop such that the working fluid contained therein may be reused indefinitely, or until routing maintenance is required.

In the illustrated embodiment, regenerator 73 may be functionally disposed between evaporator 71 and condenser 75. Regenerator 73 allows the “hot” working fluid of the present disclosure, including each of Compounds 1-4 and/or Heat Transfer Compositions 1-10 and/or Blends RB1-RB20, exiting from pump 72 and the “cold” working fluid issued from expansion device 74 to exchange some heat, potentially with a time lag between deposit of heat from the hot working fluid and release of that heat to the cold working fluid. In some applications, this can increase the overall thermal efficiency of Rankine cycle system 70.

Therefore, the disclosure relates to an organic Rankine cycle comprising a working fluid of the present disclosure, including each of Compounds 1-4 and/or Heat Transfer Compositions 1-10 and/or Blends RB1-RB20.

The disclosure also provides a process for converting thermal energy to mechanical energy in a Rankine cycle, the method comprising the steps of i) vaporizing a working fluid of the disclosure, including each of Compounds 1-4 and/or Heat Transfer Compositions 1-10 and/or Blends RB1-RB20, with a heat source and expanding the resulting vapor, then ii) cooling the working fluid with a heat sink to condense the vapor, wherein the working fluid is a refrigerant or heat transfer composition of the disclosure, including each of Compounds 1-4 and/or Heat Transfer Compositions 1-10 and/or Blends RB1-RB20.

The mechanical work may be transmitted to an electrical device such as a generator to produce electrical power.

The heat source maybe provided by, for example, a thermal energy source selected from industrial waste heat, solar energy, geothermal hot water, low pressure steam, distributed power generation equipment utilizing fuel cells, prime movers, or an internal combustion engine. The low-pressure steam is preferably a low-pressure geothermal steam or is provided by a fossil fuel powered electrical generating power plant.

The heat source is preferably provided by a thermal energy source selected from industrial waste heat, or an internal combustion engine.

It will be appreciated that the heat source temperatures can vary widely, for example from about 90° C. to >800° C., and can be dependent upon a myriad of factors including geography, time of year, etc. for certain combustion gases and some fuel cells.

Systems based on sources such as waste water or low pressure steam from, e.g., a plastics manufacturing plants and/or from chemical or other industrial plant, petroleum refinery, and related word forms, as well as geothermal sources, may have source temperatures that are at or below about 175° C. or at or below about 100° C., and in some cases as low as about 90° C. or even as low as about 80° C. Gaseous sources of heat such as exhaust gas from combustion process or from any heat source where subsequent treatments to remove particulates and/or corrosive species result in low temperatures may also have source temperatures that are at or below 200° C., at or below about 175° C., at or below about 130° C., at or below about 120° C., at or below about 100° C., at or below about 100° C., and in some cases as low as about 90° C. or even as low as about 80° C.

However, it is preferred in some applications that the heat source has a temperature of at least about 200° C., for example of from about 200° C. to about 400° C.

In an alternative preferred embodiment, the heat source has a temperature of from 400 to 800° C., more preferably 400 to 600° C.

### Heat Pumps

As discussed above, when a heat transfer fluid of the present disclosure, including each of Compounds 1-4 and/or Heat Transfer Compositions 1-10 and/or Blends RB1-RB20, used in a heat pump, it is referred to as a refrigerant. The refrigerant therefore corresponds to the heat transfer fluid as discussed in this application. All preferred features of the heat transfer fluid as described apply to the refrigerant as described herein.

The refrigerant or heat transfer composition of the disclosure, including each of Compounds 1-4 and/or Heat Transfer Compositions 1-10 and/or Blends RB1-RB20, may be used in a high temperature heat pump system.

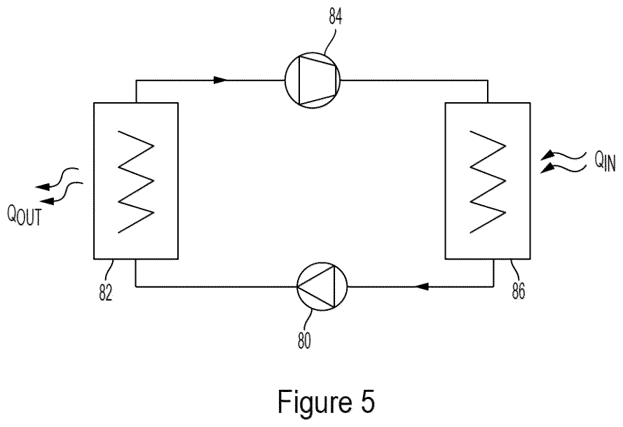

Referring to FIG. 5, in one exemplary heat pump system, compressor 80, such as a rotary, piston, screw, or scroll compressor, compresses a refrigerant of the present disclosure, including each of Compounds 1-4 and/or Heat Transfer Compositions 1-10 and/or Blends RB1-RB20, which is conveyed to a condenser 82 to release heat QOUT to a first location, followed by passing the refrigerant through an expansion device 84 to lower the refrigerant pressure, followed by passing the refrigerant through an evaporator 86 to absorb heat QIN from a second location. The refrigerant is then conveyed back to the compressor 80 for compression.

The present disclosure provides a method of heating a fluid or body using a high temperature heat pump, said method comprising the steps of (a) condensing a refrigerant composition of the present disclosure, Compounds 1-4 and/or Heat Transfer Compositions 1-10 and/or Blends RB1-RB20, in the vicinity of the fluid of body or be heated, and (b) evaporating said refrigerant.

Examples of high temperature heat pumps include a heat pump tumble dryer or an industrial heat pump. It will be appreciated the heat pump may comprise a suction line/liquid line heat exchanger (SL-LL HX). By “high temperature heat pump”, it is meant a heat pump that is able to generate temperatures of at least about 80° C., preferably at least about 90° C., preferably at least about 100° C., more preferably at least about 110° C.

### Secondary Loop System

When the heat transfer fluid of the present disclosure, including each of Compounds 1-4 and/or Heat Transfer Compositions 1-10 and/or Blends RB1-RB20, is used in a secondary loop system, it is referred to as a refrigerant.

The refrigerant of the present disclosure, including each of Compounds 1-4 and/or Heat Transfer Compositions 1-10 and/or Blends RB1-RB20, may be used as secondary refrigerant fluid in a secondary loop system.

A secondary loop system contains a primary vapor compression system loop that uses a primary refrigerant and whose evaporator cools the secondary loop fluid. The secondary refrigerant fluid, including each of Compounds 1-4 and/or Heat Transfer Compositions 1-10 and/or Blends RB1-RB20, then provides the necessary cooling for an application. The secondary refrigerant fluid should preferably be non-flammable and have low toxicity since the fluid in such a loop is potentially exposed to humans in the vicinity of the cooled space. In other words, the refrigerant or heat transfer composition of the present disclosure, including each of Compounds 1-4 and/or Heat Transfer Compositions 1-10 and/or Blends RB1-RB20, may be used as a “secondary refrigerant fluid” in a secondary loop system.

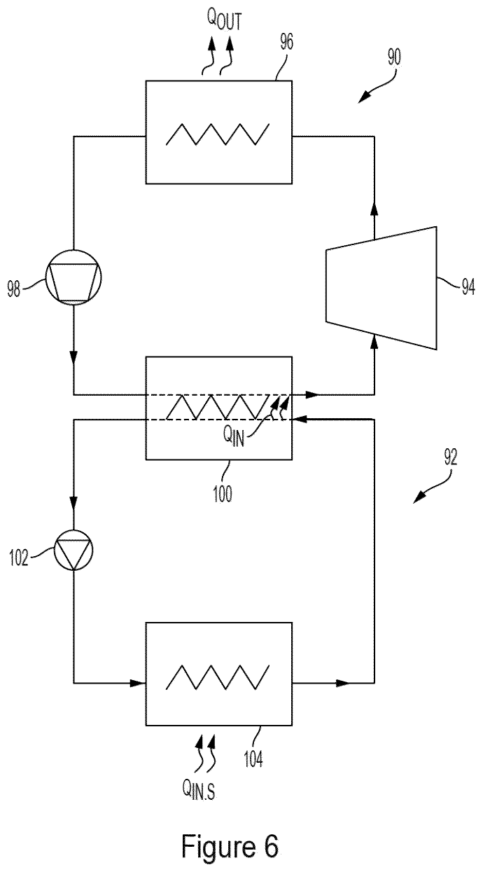

Referring to FIG. 6, one exemplary secondary loop system includes a primary loop 90 and a secondary loop 92. In primary loop 90, compressor 94, such as a rotary, piston, screw, or scroll compressor, compresses a primary refrigerant, which is conveyed to a condenser 96 to release heat QOUT to a first location, followed by passing the primary refrigerant through an expansion device 98 to lower the refrigerant pressure, followed by passing the primary refrigerant through a refrigerant/secondary fluid heat exchanger 100 to exchange heat QIN with a secondary fluid, including each of Compounds 1-4 and/or Heat Transfer Compositions 1-10 and/or Blends RB1-RB20, with the secondary fluid pumped through secondary loop 92 via a pump 102 to a secondary loop heat exchanger 104 to exchange heat with a further location, for example to absorb heat QIN-S to providing cooling to the further location.

The primary fluid used in the primary loop (vapor compression cycle, external/outdoors part of the loop) may be selected from but not limited to HFO-1234ze(E), HFO-1234yf, propane, R455A, R32, R466A, R44B, R290, R717, R452B, R448A, and R449A, preferably HFO-1234ze(E), HFO-1234yf, or propane.

The secondary loop system may be used in refrigeration or air conditioning applications, that is, the secondary loop system may be a secondary loop refrigeration system or a secondary loop air conditioning system.

Examples of refrigeration systems which can include a secondary loop refrigeration system that include a secondary refrigerant of the present disclosure, including each of Compounds 1-4 and/or Heat Transfer Compositions 1-10 and/or Blends RB1-RB20, include: a low temperature refrigeration system, a medium temperature refrigeration system, a commercial refrigerator, a commercial freezer, an industrial freezer, an industrial refrigerator, and a chiller.

Examples of air conditioning systems which can include a secondary loop air conditioning system which utilize a refrigerant of the present disclosure, including each of Compounds 1-4 and/or Heat Transfer Compositions 1-10 and/or Blends RB1-RB20, include in mobile air conditioning systems or stationary air conditioning systems. Mobile air-conditioning systems including air conditioning of road vehicles such as automobiles, trucks and buses, as well as air conditioning of boats, and trains. For example, where a vehicle contains a battery or electric power source.

Examples of stationary air conditioning systems which can include a secondary loop air conditioning system which utilize a refrigerant of the present disclosure, including each of Compounds 1-4 and/or Heat Transfer Compositions 1-10 and/or Blends RB1-RB20, include: a chiller, particularly a positive displacement chiller, more particularly an air cooled or water-cooled direct expansion chiller, which is either modular or conventionally singularly packaged, a residential air conditioning system, particularly a ducted split or a ductless split air conditioning system, a residential heat pump, a residential air to water heat pump/hydronic system, an industrial air conditioning system, a commercial air conditioning system, particularly a packaged rooftop unit and a variable refrigerant flow (VRF) system, and a commercial air source, water source or ground source heat pump system.

A particularly preferred heat transfer system according to the present disclosure is an automotive air conditioning system comprising a vapour compression system (the primary loop) and a secondary loop air conditioning system, wherein the primary loop contains HFO-1234yf as the refrigerant and the second loop contains a refrigerant or heat transfer composition of the present disclosure, including each of Compounds 1-4 and/or Heat Transfer Compositions 1-10 and/or Blends RB1-RB20. In particular, the secondary loop can be used to cool a component in the car engine, such as the battery.

It will be appreciated the secondary loop air conditioning or refrigeration system may comprise a suction line/liquid line heat exchanger (SL-LL HX).

The present heat transfer fluids, or heat transfer compositions which can include a secondary loop air conditioning system which utilize a refrigerant of the present disclosure, including each of Compounds 1-4 and/or Heat Transfer Compositions 1-10 and/or Blends RB1-RB20, may be used as a replacement for existing fluids.

The disclosure includes a method of replacing an existing heat transfer fluid in a heat transfer system, said method comprising the steps of (a) removing at least a portion of said existing heat transfer fluid from said system, and subsequently (b) introducing into said system a heat transfer fluid of the disclosure. Step (a) may involve removing at least about 5 wt. %, at least about 10 wt. %, at least about 15 wt. %, at least about 50 wt. % at least about 70 wt. %, at least about 90 wt. %, at least about 95 wt. %, at least about 99 wt. % or at least about 99.5 wt. % or substantially all of said existing heat transfer fluid from said system prior to step (b).

The method may optionally comprise the step of flushing said system with a solvent after conducting step (a) and prior to conducting step (b).

For the purposes of this disclosure, the heat transfer fluid of the present disclosure, including each of Compounds 1-4 and/or Heat Transfer Compositions 1-10 and/or Blends RB1-RB20, can be used to replace an existing fluid in an electronic device, in an Organic Rankine cycle, in a high temperature heat pump or in a secondary loop.

For example, the thermal management composition of the disclosure, including each of Compounds 1-4 and/or Heat Transfer Compositions 1-10 and/or Blends RB1-RB20, may be used as a replacement for existing fluids such as HFC-4310mee, HFE-7100 and HFE-7200. Alternatively, the thermal management composition, including each of Compounds 1-4 and/or Heat Transfer Compositions 1-10 and/or Blends RB1-RB20, can be used to replace water and glycol. The replacement may be in existing systems, or in new systems which are designed to work with an existing fluid. Alternatively, the thermal management composition, including each of Compounds 1-4 and/or Heat Transfer Compositions 1-10 and/or Blends RB1-RB20, can be used in applications in which the existing refrigerant was previously used. Alternatively, the refrigerant of the present disclosure, including each of Compounds 1-4 and/or Heat Transfer Compositions 1-10 and/or Blends RB1-RB20, may be used to retrofit an existing refrigerant in an existing system. Alternatively, the refrigerant of the present disclosure, including each of Compounds 1-4 and/or Heat Transfer Compositions 1-10 and/or Blends RB1-RB20, may be used in new systems which are designed to work with an existing refrigerant.

The disclosure provides a method of replacing an existing refrigerant in a heat transfer system, said method comprising the steps of (a) removing at least a portion of said existing refrigerant from said system, and subsequently (b) introducing into said system a refrigerant of the disclosure of the present disclosure, including each of Compounds 1-4 and/or Heat Transfer Compositions 1-10 and/or Blends RB1-RB20. The existing refrigerants may be selected, for example, from HFC-4310mee, HFE-7100 and HFE-7200.

Step (a) may involve removing at least about 5 wt. %, at least about 10 wt. %, at least about 15 wt. %, at least about 50 wt. % at least about 70 wt. %, at least about 90 wt. %, at least about 95 wt. %, at least about 99 wt. % or at least about 99.5 wt. % of said existing refrigerant from said system prior to step (b).

The method may optionally comprise the step of flushing said system with a solvent after conducting step (a) and prior to conducting step (b).

### Solvent and Cleaning Uses, Methods, and Systems

The present disclosure provides solvating methods. Such methods include cleaning methods generally, etching methods, carrier solvent applications (for coating applications, lubricant deposition, silicone deposition, and other coatings, including in connection with coatings of medical devices heparin and PTFE for example).

With respect to cleaning methods, all such methods are included within the scope of the present disclosure. Preferred cleaning methods include vapor degreasing by contacting the article, device or component thereof with a composition of the present disclosure, including each of Compounds 1-4 and Compositions 1-4. A wide variety of contaminants can be removed from a wide variety of article, device and components. Examples of contaminants that can be removed using a composition of the present disclosure, including each of Compounds 1-4 and Compositions 1-4 include, for example, light oils, medium oils, fluorolubes, greases and silicones and waxes. Examples of article, device and components that can be cleaned using a composition of the present disclosure, including each of Compounds 1-4 and Compositions 1-4 include, for example electronic components (including silicon wafers, PCBs, semiconductor surfaces), precision parts (including aircraft parts and components) light oils, medium oils, fluorolubes, greases and silicones and waxes.

Preferred solvent vapor phase degreasing and defluxing methods of the present disclosure include immersing a soiled substrate or part (e.g., a printed circuit board or a fabricated metal, glass, ceramic, plastic, or elastomer part or composite) or a portion of a substrate or part into a boiling, non-flammable liquid in accordance with the present disclosure, including each of Compounds 1-4 and Compositions 1-4, followed by rinsing the part in a second tank or cleaning zone by immersion or distillate spray with a clean solvent which can also be any one of the compositions of the present disclosure. The parts are then dried by maintaining the cooled part in the condensing vapours until temperature has reached equilibrium.

Solvent cleaning of various types of parts generally occurs in batch, hoist-assisted batch, conveyor batch, or in-line type conveyor degreaser and defluxer equipment. Parts may also be cleaned in open top defluxing or degreasing equipment. In both types of equipment, the entrance and/or exit ends of the equipment can be in open communication with both the ambient environment and the solvent within the equipment. In order to minimize the loss of solvent from the equipment by either convection or diffusion, a common practice in the art is to use.

The present disclosure includes solvent compositions comprising any of Compounds 1-4 in combination with a co-solvent. The co-solvent may be selected from the group consisting of hexafluoroisopropylethylether, hexafluoroisopropylmethylthioether, HFE-7000, HFE-7200, HFE-7100, HFE-7300, HFE-7500, HFE-7600, trans-1,2-dichloroethylene, n-pentane, cyclopentane, ethanol, perfluoro(2-methyl-3-pentanone) (Novec 1230), cis-HFO-1336mzz, trans-HFO-1336mzz, HF-1234yf, HFO-1234ze(E), HFO-1233zd(E) and HFO-1233zd(Z).

### Electrolyte Formulations and Batteries

The present disclosure also provides electrolyte formulations, and batteries containing electrolyte formulations, which comprise a compound of the present disclosure, including each of Compounds 1-4 and Compositions 1-4. In general, the electrolyte formulations comprise: (a) electrolyte; (b) organic solvent for the electrolyte; and (c) additives that are included in the formulation to provide a desired property, or an improvement to a desired property, of the electrolyte formulation and/or of the battery which contains the electrolyte. The compounds of the present disclosures, including each of Compounds 1-4 and Compositions 1-4, can be included in the formulation as a solvent (or co-solvent) for the electrolyte and/or as an additive.

Thus, the present disclosure provides electrolyte formulations comprising: a salt, preferably lithium-ion salt; a solvent for the salt, said solvent comprising a compound of the present disclosure, including each of Compounds 1-4 and Compositions 1-4, either with or without a co-solvent; and one or more additives different than the compounds of the present disclosure. The present disclosure also provides electrolyte formulations comprising: electrolyte, and preferably lithium ion electrolyte; (b) solvent for the lithium-ion electrolyte; and (c) an additive comprising a compound of the present disclosure, including each of Compounds 1-4 and Compositions 1-4, either with or without additional additives.

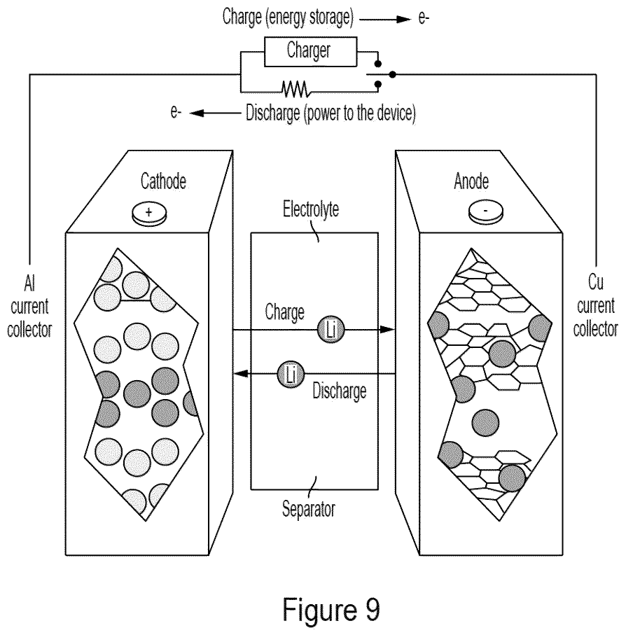

The present disclosure also provides batteries in general, and rechargeable lithium-ion batteries in particular, which contain an electrolyte formulation containing a compound of the present disclosure, including each of Compounds 1-4 and Compositions 1-4. An exemplary rechargeable lithium-ion battery is illustrated in FIG. 9 hereof, which shows a cathode and an anode and electrolyte formulation of the present disclosure which facilitates the flow of lithium ions between the cathode and the anode.

Although it is contemplated that the present electrolyte formulations may be useful in batteries in general, in preferred embodiments the electrolyte formulation comprises a lithium-ion electrolyte useful in rechargeable batteries. Non-limiting examples of lithium salts that may comprise the electrolyte portion of the formulation include: LiPF₆, LiAsF₆, LiCIO₄*LiBF₄, LiBC₄Og(LiBOB), LIBCO₄F, (LIODFB), LiPF₃(C₂F₅)₃(LiFAP), LiBF₃(C₂F₅)LiPF₃(C,F₅)₃(LiFAB), LIN, (CF₃SO,) LIN(C,F₅SO,), LiCF₃S0₃, LiC(CF₃SO)₃, LiPF₄(CF₃)₂, LiPF₃(CF₃)₃, LiPF₃(iSO-C₃C₇)₃, LiPF₅(iso-C₃F₇). The overall salt concentration may vary depending on the particular needs of the application, in some embodiments the electrolyte may be present in the formulation in an amount between about 0.3M and about 2.5M or, from about 0.7M to about 1.5M.

### EXAMPLES

### Example 1—Synthesis of 3-(difluoromethoxy)-1,1,2,2-tetrafluoropropane

In a 2-L three-necked flask equipped with a mechanic stirrer and water-cooled condenser, which was connected to a dry-ice trap before enter the air, are charged with 400 ml diglyme, 153.0 g of 2,2,3,3,3-pentafluoro-1-propanol, 800 g 25% wt. NaOH. The mixture was heated to 30° C. with stirring while 103.8 g of R22 was bubbled through a sparger into the mixture at 150 ml/min rate (duration about 3.5 hours), while the heating was stopped when addition of R22 started The internal temperature was maintained around 30° C. by controlling the R22 speed and with intermittent ice-water cooling if the internal temperature rose to 40° C. After completion, the mixture was cooled to room temperature and quenched into 3-L ice-water. The bottom organic layer was collected, and 185.6 g crude mixture was separated with a GC yield of 32% 3-(difluoromethoxy)-1,1,2,2-tetrafluoropropane.

### Example 2—Synthesis of Synthesis of 3-(difluoromethoxy)-1,1,2,2-tetrafluoropropane

147.6 g of 2,2,3,3-tetrafluoro-1-propanol, 50 ml of diglyme, and 2.3 g of aliquat 336, and 116.8 difluorochloromethane in 600 ml SS autoclave were reacted with 361.2 50 wt. % of sodium hydroxide at 15-30° C. for 4 h, then 23° C. overnight. After completion, the pressure in autoclave was released through a 10% potassium hydroxide caustic solution, and the reaction content was quenched into a 1.5 L DI water, and bottom organic layer was collected, 195.0 g clear liquid. GC showed 65.9% product in the mixture, 3-(difluoromethoxy)-1,1,2,2-tetrafluoropropane, with a GC yield of 63.2%.

### Example 3—Synthesis of Synthesis of 3-(difluoromethoxy)-1,1,2,2-tetrafluoropropane

143.2 g of 2,2,3,3-tetrafluoro-1-propanol, 50 ml of diglyme, and 2.1 g of aliquat 336, and 114.8 g difluorochloromethane in 600 ml SS autoclave were reacted with 353 g 50 wt. % of sodium hydroxide at 15-45° C. for 4 h, then 23° C. overnight. After completion, the pressure in autoclave was released through a 10% potassium hydroxide caustic solution, and the reaction content was quenched into a 1.5 L DI water, and bottom organic layer was collected, 184.0 g clear liquid. GC showed 55.3% product in the mixture, 3-(difluoromethoxy)-1,1,2,2-tetrafluoropropane, with a GC yield of 51.5%.

The 3-(difluoromethoxy)-1,1,2,2-tetrafluoropropane crude product collected from example 5 and 6 typically contained side product 1,1,2,2-tetrafluoro-3-fluoro(2,2,3,3-tetrafluoropropoxy)methoxy)propane ((CF2HCF2CH2O)2CHF) 3.8%, and tris(2,2,3,3-tetrafluoropropoxy)methane ((CF2HCF2CH2O)3CH) 2.8%, plus some solvent. The dimer (CF2HCF2CH2O)2CHF tended to lose HF during the storage an distillation, and was corrosive to the glassware. Thus, the crude product mixture was combined and rotovaped under 100 torr vacuum. The collected liquid products in the dry-ice trap was free of dimer and trimers. Crude mixture 531.5 (GC 53.2%) gave 304 g clear liquid after rotovap, with GC purity of 88.2% plus some starting material and solvent, and no more dimer or trimer in the mixture.

### Example 4—Synthesis of 3-(difluoromethoxy)-1.1.1.2.2-pentafluoropropane

153.0 g of 2,2,3,3,3-pentafluoro-1-propanol, 50 ml of diglyme, and 2.2 g of aliquat 336, and 124.2 g difluorochloromethane (R22) in 600 ml SS autoclave were reacted with 411.8 g 50 wt. % of sodium hydroxide at 15-23° C. for 16 h. After completion, the pressure in autoclave was released through a 10% potassium hydroxide caustic solution, and the reaction content was quenched into a 1.5 L DI water, and bottom organic layer was collected, 186.9 g clear liquid. GC showed 46.94% product in the mixture, 3-(difluoromethoxy)-1,1,1,2,2-pentafluoropropane, with a GC yield of 42.9%.

### Example 5—Synthesis of 3-(difluoromethoxy)-1,1,1,2,2-pentafluoropropane

In a 2 L three-necked flask equipped with a mechanic stirrer is charged with 100 ml dioxane, 148.8 g 2,2,3,3,3-pentafluoro-1-propanol, and 408 g of 50 wt. % NaOH. The mixture is heated to 50 C, then stopped, while R22 is bubbled into the solution at 100 ml/min for 4.5 hours, GCMS showed 13% starting material remains, and R22 was kept feed for another 1.5 hours till no starting material in the mixture. The mixture was cooled to 20° C. and quenched into 1.5 L ice water. 81.9 g of clear liquid was collected from the bottom layer, GC showed 59.4% product plus other side products, GC yield 24.3%.

### Example 6—Synthesis of 3-(difluoromethoxy)-1,1,1,2,2-pentafluoropropane

150.5 g of 2,2,3,3,3-pentafluoro-1-propanol and 70 ml of diglyme in 600 ml SS autoclave were cooled with dry-ice acetone mixture to −60° C., and vacuumed. 110 g difluorochloromethane (R22) was condensed into the vessel and sealed. 409 g of 50 wt. % of sodium hydroxide was added via an Eldex liquid pump at 1.5 ml/min with stirring at 23-39 C for 4 h, and stirred at 23° C. over night after addition. After completion, the pressure in autoclave was released through a 10% potassium hydroxide caustic solution, and the reaction content was quenched into a 1.5 L DI water, and bottom organic layer was collected, 143.5 g clear liquid. GC showed 53.6% product in the mixture, 3-(difluoromethoxy)-1,1,1,2,2-pentafluoropropane, with a GC yield of 38.4%.

The 3-(difluoromethoxy)-1,1,1,2,2-pentafluoropropane crude product collected from example 5 and 6 typically contained side product 1,1,1,2,2-pentafluoro-3-fluoro(2,2,3,3,3-pentafluoropropoxy)methoxy)propane ((CF3CF2CH2O)2CHF) 10.6%, and tris(2,2,3,3,3-tetrafluoropropoxy)methane ((CF3CF2CH2O)3CH) 2.5%, plus some solvent. The combined crude product 298.7 g (GC 31%) was distilled through a 1-foot packed column to give 101.8 g of 98.5% 3-(difluoromethoxy)-1,1,1,2,2-pentafluoropropane, plus some cuts with impurities.

### Example 7—Synthesis of 4-(difluoromethoxy)-1,1,1,2,2,3,3-heptafluorobutane

100 g of 2,2,3,3,4,4,4-heptafluoro-1-butanol, 400 ml of 21% NaOH in water, and 350 ml of Diglyme were added to a 1 L autoclave (leak tested), and sealed. Temperature and pressure inside the autoclave were recorded. Autoclave was heated to 50° C. and the heat jacket was removed once temperature was reached the designated temperature. 60 g of R22 (CHF2Cl) was bubbled into autoclave at rate of 0.25 g-0.4 g/minute with stirring.

The stirring was continued for additional 2-3 h after the R22 addition is complete. Then, the reaction mixture was transferred to 5 L flask, and the reaction mixture was subjected to vacuum transfer for 1.5 h, and the products were collected by dry-ice then liquid nitrogen traps. The products in the traps were allowed to warm to RT, then 5washed with 50 ml of water twice in a separate funnel. The bottom organic layer was collected, 76 g, GC showed 85% of 4-(difluoromethoxy)-1,1,1,2,2,3,3-heptafluorobutane in the mixture, GC yield 52%.

### Example 8—Dielectric Constant Measurements

Static dielectric constant for new molecules was calculated using Kirkwood theory as described in papers by Wang and Anderko [P. Wang and A. Anderko, Computation of dielectric constants of solvent mixtures and electrolyte solutions, Fluid Phase Equilibria 186 (2001) 103-122] and Harvey and Lemmon [A. H. Harvey and E. W. Lemmon, Method for estimating dielectric constant of natural gas mixtures, International Journal of Thermophysics 26 (2005) 31-46].

Experimental dielectric property measurements were made on all liquids using the Agilent 85070 Dielectric Probe. All measurements were made at ambient pressure and room temperature (approximately 23° C.). Prior to making measurements, the system was calibrated from 1 GHz to 20 GHz with an open circuit, a short circuit, and DI water (@22.4° C.) standard. The result of the calibration is shown in the Table 5 below for DI H2O, and is consistent with DI water at 22.4° C. The accuracy of the probe is given as: Dielectric constant, er′=er′+/−0.05|er*| with er″=er″+/−0.05|er*| and (loss=er″/er′).

TABLE 5

| | | | Calculated | Experimental | Experimental Loss |
|---|---|---|---|---|---|
| Name | Formula | Bp/° C. | Dk at 1 KHz | Dk at 1 GHz | Tangent at 1 GHZ |
| Compound 1 | CHF₂CF₂CH₂OCHF₂ | 76 | 1.76 | 2.94 | 0.036 |
| Compound 2 | CF₃CF₂CH₂OCHF₂ | 46 | 2.94 | 5.21 | 0.038 |
| Compound 3 | (CF₃)₂CHOCHF₂ | 41 | 5.19 | N/A | N/A |
| Compund 4 | CF₃CF₂CF₂CH₂OCHF₂ | 69 | 2.44 | 4.51 | 0.054 |
| DI Water | H₂O | 100 | N/A | 79.15 | 0.052 |
| Experimental | | | | | |
| Standard | | | | | |

### Example 9—Organic Rankine Cycle

This example illustrates that the compositions of the present disclosure, including each of Compounds 1-4 and/or Heat Transfer Compositions 1-10 and/or Blends RB1-RB20, are useful as a working fluid in an Organic Rankine cycle based on a comparison of the estimated thermal efficiency of various working fluids in an organic Rankine cycle. In this example, an ORC system is assumed to contain a condenser, pump, boiler and turbine and the following qualitative results will occur as shown in Table 6 below.

TABLE 6

| | | Process Specifications | | | | | | |
|---|---|---|---|---|---|---|---|---|
| | | | | Boiler | | | | |
| | | Boiler | Critical | Super- | Isentropic | Condensing | Isentropic | Estimated |
| | | Temp | Temp | heat | Efficiency | Temp | Efficiency | Thermal |
| Example | Working Fluid | (° C.) | (° C.) | (° C.) | (Turbine) | (° C.) | (Pump) | Efficiency |
| Ex. 9A | Compounds 1-4 | 144 | 225 | 1 | 0.8 | 35 | 0.8 | 15-20% |
| | and/or Heat | | | | | | | |
| | Transfer | | | | | | | |
| | Compositions 1-10 | | | | | | | |
| | and/or Blends | | | | | | | |
| | RB1-RB20 | | | | | | | |
| | R245fa | 144 | 154 | 1 | 0.8 | 35 | 0.8 | 15.41% |
| | R1233zd(E) | 144 | 166 | 1 | 0.8 | 35 | 0.8 | 15.92% |
| Ex. 9B | Compounds 1-4 | 210 | 225 | 1 | 0.8 | 35 | 0.8 | 15-20% |
| | and/or Heat | | | | | | | |
| | Transfer | | | | | | | |
| | Compositions 1-10 | | | | | | | |
| | and/or Blends | | | | | | | |
| | RB1-RB20 | | | | | | | |
| | R245fa | 144 | 154 | 1 | 0.8 | 35 | 0.8 | 15.41% |
| | R1233zd(E) | 156 | 166 | 1 | 0.8 | 35 | 0.8 | 16.66% |

### Example 10

Batteries of electric vehicles develop heat during operation when charging and discharging. The typical design of vehicle batteries differs between three types: cylindrical cells, pouch cells and prismatic cells. All three types have different considerations in terms of heat transfer due to their shape. Prismatic and pouch cells are often used with cooling plates due to the straight outer faces. Cylindrical cells employ cooling ribbons that are in thermal contact with the outer shell of the cells. Extensive heat generation during charging and discharging of the cells can lead to an increase in temperature that can cause decreasing performance and reduced battery lifetime.

A battery cooling plate set up may be used to provide active cooling to a battery and remove the heat (e.g., to remove heat from the battery of an electric vehicle). In this Example, the performance of fluids of the present disclosure, including each of Compounds 1-4 and/or Heat Transfer Compositions 1-10 and/or Blends RB1-RB20 and 3M Novec 7200 is analyzed for its ability to provide cooling in single phase heat transfer.

It will be appreciated that the convective heat transfer can occur either by direct contact, i.e., when the battery is immersed in the fluid that may be pumped through the battery enclosure or indirectly, i.e., by using a cooling plate with a combination of convective and conductive heat transfer.

The present example uses a round tube with an internal diameter of 0.55 inches to provide a cooling load of 10246 BTU/h (3 kW). The tube length was 30 ft (9.14 m) with an assumed pressure drop of 2.9PSI (20 kPa). The fluid temperature was 7.2 C (45 F). The internal heat transfer coefficient is determined for turbulent flow. The necessary mass flow rate to remove the cooling load is determined for both fluids. The results of the comparison are shown in the Table 7 below. It can be seen in the results that the necessary mass flow rate to remove the generated heat is about or less than for 3M Novec 7200 and that the useful output (I.e., the heat transfer coefficient) is about or higher than 3M Novec 7200.

TABLE 7

| | Mass | Prandtl | Internal heat |
|---|---|---|---|
| | Flow Rate | Number | transfer coefficient |
| Fluid | (lb./s) | [—] | BTU/(h-ft2-F) |
| Compounds 1-4 | 0.9-1 | 9-11 | 300-350 |
| and/or Heat Transfer | | | |
| Compositions 1-10 | | | |
| and/or Blends RB1- | | | |
| RB20 | | | |
| 3M Novec 7200 | 0.98 | 10.4 | 303.4 |

### Example 11—Secondary AC System

The efficiency of secondary loop air conditioning system, as determined by the estimated coefficient of performance (COP), is evaluated for the use of heat each of Compounds 1-4 and/or Heat Transfer Compositions 1-10 and/or Blends RB1-RB20 as a secondary refrigerant with R1234ze(E), R1234yf, and propane as primary refrigerant options. The system is composed of a vapor-compression primary loop and a pumped two-phase secondary loop that are thermally connected by an internal heat exchanger. This internal heat exchanger acted as an evaporator for the primary loop and a condenser for the secondary loop. Using the thermodynamic properties of the primary and secondary refrigerants at the specified conditions of each unit operation, defined in Table 8, the COP is evaluated relative to the performance of R410A in an air conditioning system (see Table 9).

TABLE 8

| | | | | | | | | | Intermediate | Intermediate |
|---|---|---|---|---|---|---|---|---|---|---|
| | | | Sub- | | Evap | Super | | | Heat Exchanger | Heat Exchanger |
| Operating | Condition | Sink | Cooling | Evap | Sink | heat | Isentropic | Volumetric | Superheat | Saturation |
| Conditions | (° C.) | (° C.) | (° C.) | (° C.) | (° C.) | (° C.) | (—) | (—) | (° C.) | (° C.) |
| Basic Cycle | 45 | 35 | −5 | 7 | 27 | +5 | 70% | 100% | N/A | N/A |
| (R410A) | | | | | | | | | | |
| Secondary | 45 | 35 | −5 | 7 | 27 | 0 (flooded) | 70% | 100% | +5 | +5 |
| Cycle | | | | | | | | | | |
| Compounds | | | | | | | | | | |
| 1-4 and/or | | | | | | | | | | |
| Heat Transfer | | | | | | | | | | |
| Compositions | | | | | | | | | | |
| 1-10 and/or | | | | | | | | | | |
| Blends RB1- | | | | | | | | | | |
| RB20 | | | | | | | | | | |

TABLE 9

| Primary | | | | | |
|---|---|---|---|---|---|
| Refrigerant | Secondary | GWP | GWP | | |
| (“X”) | Refrigerant | Primary | Secondary | Capacity | Efficiency |
| R410A | Compound 1 | 1924 | | 100% | 100% |
| R1234ze(E) | Compound 2 | <1 | <1-150 | 100% | 90-95% |
| R1234yf | Compound 3 | <1 | <1-150 | 100% | 90-95% |
| Propane | Compound 4 | 3 | <1-150 | 100% | 90-95% |

Table 9 shows the thermodynamic performance of the secondary AC system with different primary refrigerants and using each of Compounds 1-4 as a secondary refrigerant, with the capacity of the secondary AC system being matched to R410A system in all the cases.

### Example 12—High Temperature Heat Pump Applications

High temperature heat pumps can utilize waste heat and provide high heat sink temperatures. Compounds 1-4 and/or Heat Transfer Compositions 1-10 and/or Blends RB1-RB20 in Table 4 of the present disclosure each provide efficiency equal to about or superior to R245fa over a wide range of condensing temperatures. The following operating conditions were used
Condensing temperature varied between 90° C., 100° C. and 110° C.
Subcooling: 10° C.
Evaporating temperature: 25° C.
Evaporator Superheat: 15° C.
Isentropic efficiency: 65%

TABLE 10

| | Condensing temperature | | |
|---|---|---|---|
| Fluid | 90° C. | 100° C. | 110° C. |
| R245fa | 100.0% | 100.0% | 100.0% |
| Compounds 1-4 | 100-105% | 100-105% | 100-105% |

### Example 13—Thermodynamic Performance of a Secondary Loop Medium Temperature Refrigeration System

The efficiency of secondary loop medium temperature refrigeration system, as determined by the estimated coefficient of performance (COP), is evaluated for the use of each of Compounds 1-4 and/or Heat Transfer Compositions 1-10 and/or Blends RB1-RB20, with R1234ze(E), R1234yf, and propane as primary refrigerant options. The system is composed of a vapor-compression primary loop and a pumped two-phase secondary loop that are thermally connected by an internal heat exchanger. This internal heat exchanger acts as an evaporator for the primary loop and a condenser for the secondary loop. The COP was evaluated relative to the performance of R134a in an air conditioning system and the each of Compounds 1-4 and/or Heat Transfer Compositions 1-10 and/or Blends RB1-RB20 about matches or is superior to the efficiency of R134a.

### Example 14A—Singe Phase Sensible Heat Immersion Cooling in Battery Applications

Batteries of electric vehicles develop heat during operation when charging and discharging. The typical design of vehicle batteries differs between three types: cylindrical cells, pouch cells and prismatic cells. All three types have different considerations in terms of heat transfer due to their shape. Extensive heat generation during charging and discharging of the cells can lead to an increase in temperature that can cause decreasing performance and reduced battery lifetime.

Compounds 1-4 and/or Heat Transfer Compositions 1-10 and/or Blends RB1-RB20 preferably have low dielectric constants, high dielectric strength, and are non-flammable fluids, which allows for direct cooling of the battery cells that are immersed in each of Compounds 1-4 and/or Heat Transfer Compositions 1-10 and/or Blends RB1-RB20.

The present example considers a battery module that consists of 1792 cylindrical battery cells of 18650 type. In one case the battery module is cooled by a 50/50 mixture of water/glycol in a flat tube heat exchanger that is on contact with the battery cells. In the other case the cells are immersed in each of Compounds 1-4 and/or Heat Transfer Compositions 1-10 and/or Blends RB1-RB20, i.e., are in direct contact with the fluid. The waste heat for the battery module is 8750 W that is evenly distributed over the total number of cells. The assumptions and operating conditions are listed in Table 11 and Table 12.

TABLE 11

| | | | Compounds 1-4 |
|---|---|---|---|
| | | | and/or Heat Transfer |
| | | | Compositions 1-10 |
| | | Water/ | and/or Blends |
| Parameter | Unit | Glycol | RB1-RB20 |
| Battery diameter | [mm] | 18.5 | 18.5 |
| Battery gap | [mm] | 3.8 | 1.5 |
| Battery height | [mm] | 65 | |
| Number of batteries | [—] | 1792 | |
| Battery mass | [g] | 49 | |
| Battery specific heat | [J/kgK] | 830 | |
| Total battery module | [W] | 8750 | |
| waste heat | | | |
| Fluid flow rate | [kg/s] | 0.1 | |
| Initial module temperature | [° C.] | 30 | |
| Fluid inlet temperature | [° C.] | 10 | |
| Cooling channel height | [mm] | 30 | n/a |
| Cooling channel width | [mm] | 2.8 | n/a |
| Heat exchanger flat tube | [mm] | 0.5 | n/a |
| wall thickness | | | |
| Heat exchanger flat tube | [W/mK] | 3 | n/a |
| thermal conductivity | | | |
| Heat exchanger flat tube | [—] | 0.0003 | n/a |
| relative surface roughness | | | |

TABLE 12

| | Minimum cell | | | |
|---|---|---|---|---|
| | temperature [° C.] | | Maximum cell | |
| | | Compounds 1-4 | temperatures [° C.] | |
| | Water/ | and/or Heat Transfer | Water/ | |
| | Glycol | Compositions 1-10 and/ | Glycol | Compounds |
| Time | 50/50 | or Blends RB1-RB20 | 50/50 | 1-4 |
| 0 | 30.0 | 30.0 | 30.0 | 30.0 |
| 100 | 35.8 | 10-40 | 36.8 | 30-40 |
| 200 | 40.3 | 10-40 | 42.0 | 30-40 |
| 300 | 43.6 | 10-45 | 46.0 | 30-45 |
| 400 | 46.1 | 10-45 | 49.2 | 30-50 |
| 500 | 48.0 | 10-45 | 51.7 | 30-50 |
| 600 | 49.5 | 10-50 | 53.6 | 30-55 |
| 700 | 50.5 | 10-50 | 55.1 | 30-55 |
| 800 | 51.4 | 10-50 | 56.3 | 30-55 |
| 900 | 52.0 | 10-50 | 57.2 | 30-55 |

### Example 14B—Single Phase Sensible Heat Data Center Cooling

Data centers, also described herein as server banks or server hubs, are designed to maximize computing and storage capacity while minimizing space requirements. This results in densely packed arrays of servers and networking gear which can lead to concentrated heat generation. In addition, data centers operate around the clock, further contributing to heat build-up. With effective cooling, the efficiency and longevity of server hardware can be improved.

Compounds 1-4 and/or Heat Transfer Compositions 1-10 and/or Blends RB1-RB20 preferably have low dielectric constants, high dielectric strength, and are non-flammable fluids, which allows for direct cooling of the data centers that are immersed in each of Compounds 1-4 and/or Heat Transfer Compositions 1-10 and/or Blends RB1-RB20.

A data center is cooled with Compounds 1-4 and/or Heat Transfer Compositions 1-10 and/or Blends RB1-RB20 and the system operates effectively, efficiently, safely and reliably. The electronic components are kept in the most desired operating temperature range while the data center is performing its functions.

### Example 15A—Two Phase Immersion Cooling in Data Center Applications

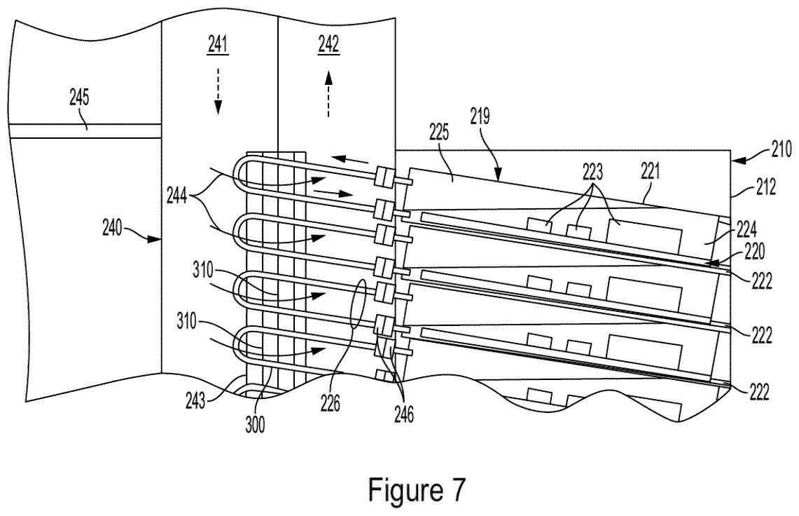

An example of data center cooling is provided, making reference to FIG. 7. A data center, generally denoted 200, includes a plurality of electronic subsystems 220 contained in one or more of electronics racks 210. At least one, and preferably a plurality, and preferably all, of the electronic subsystems 220 are associated with a cooling station 240 that includes (in one embodiment) a vertically extending, liquid-to-air heat exchanger 243 and supply and return ducting 241, 242 for directing a cooling airflow 244 across liquid-to-air heat exchanger 243. A cooling subsystem 219 is associated with at least one, and preferably a plurality, and preferably all, of the multiple electronic subsystems 220. In a preferred embodiment, as shown in FIG. 7, all of the subsystem 220 are associated with the cooling station 240 and a cooling subsystem 219. Each cooling subsystem 219 comprises (in this embodiment) a housing 221 (which preferably is a low-pressure housing) which encloses a respective electronic subsystem 220 comprising a plurality of electronic components 223. The electronic components are in operation as part of the data center and are generating heat as a result of performing their function in the data center. The components include, by way of example, printed circuit boards, microprocessor modules, and memory devices. Each electronic subsystem has, as it is operating, its heat generating components immersed in a thermal management composition of the present disclosure 224, including each of Compounds 1-4 and/or Heat Transfer Compositions 1-10 and/or Blends RB1-RB20. The fluid 224 boils in typical operation, generating dielectric vapor 225 according to the present disclosure. In the illustrated embodiment, electronic subsystems 220 are angled by providing upward-sloped support rails 222 within electronics rack 210 to accommodate the electronic subsystems 220 at an angle. Angling of the electronic subsystems as illustrated facilitates buoyancy-driven circulation of vapor 225 between the cooling subsystem 219 and the liquid-to-air heat exchanger 243 of the associated local cooling station 240. However, the excellent results according to the present disclosure and the present example are achieved equally well when such angling is not used. Multiple coolant loops 226 are coupled in fluid and thermal contact with the liquid-cooled electronic subsystems and a respective portion of liquid-to-air heat exchanger 243. In particular, multiple tubing sections 300 pass through liquid-to-air heat exchanger 243, which in this example includes a plurality of air-cooling fins 310. Vapor 225 is buoyancy-driven from housing 221 to the corresponding tubing section 300 of liquid-to-air heat exchanger 243, where the vapor condenses and is then returned as liquid to the associated liquid-cooled electronics subsystem. Cooling airflow 244 is provided in parallel to the supply ducting 241 of multiple local cooling stations 240 of data center 200, and the heated airflow is exhausted via return ducting 242. The equipment as described herein, but not the fluid of the present disclosure, is disclosed in US 2013/0019614, which is incorporated herein by reference.

The system as described above is operated with a thermal management composition consisting of the present disclosure, including each of Compounds 1-4 and/or Heat Transfer Compositions 1-10 and/or Blends RB1-RB20 and ambient air as the heat sink for the condenser, and this system operates to effectively, efficiently, safely and reliably maintain the electronic components in the most desired operating temperature range while the system is performing its function in the operating data center.

### Example 15B—Two Phase Immersion Cooling of Batteries

As described in Example 15A above, Compounds 1-4 and/or Heat Transfer Compositions 1-10 and/or Blends RB1-RB20 are suitable as thermal management compositions for two-phase immersion cooling systems.

In this example, the two-phase immersion cooling system of Example 15A is used to cool an array of batteries. The immersion cooling system effectively, efficiently, safely and reliably maintains the batteries in the most desired operating temperature range.

### Example 16—Compounds 1-4 as a Solvent or Additive in Lithium-Ion Batteries

Electrolyte solvents and additives play an important role in the performance of lithium-ion batteries (LIB). Compounds 1-4 of the present disclosure is used as a solvent or additive for various electrolyte composition for lithium-ion batteries. Typically, the electrolyte composition comprises dissolved Li salt such as lithium hexafluorophosphate (LiPF₆), Lithium bis(fluorosulfonyl)imide (LiFSI), lithium trifluoromethanesulfonate (LiTf), solvents or combination of solvents comprising components such as ethylene carbonate (EC), propylene carbonate (PC), diethylene carbonate (DEC), dimethylene carbonate (DMC) and many other organic carbonates and esters and additives such vinylene carbonate, crown ethers, borates, boronates and many other compounds. The role of solvents in LIB is to serve as the medium for the transfer of charges, which are in the form of ions, between a pair of electrodes. Various modifications of the electrolytes with different components of solvents or additives are also known [For a detailed description, see Kang Xu, “Non-Aqueous Electrolytes for Lithium Based Rechargeable Batteries” Chem. Rev., 2012, 104, 4303-4417]. Compounds of the present disclosure, including Compounds 1-4, can be added as solvents and/or additives to improve the performance of lithium-ion batteries since such the present material have desirable properties such as chemical and thermal stability, desirable dielectric constant and electrochemical window. The present compounds and compositions can be used as a solvent in amounts, for example, ranging from 5-50 wt. % of the solvent, and as additives, in amounts ranging from 0.1 to 5 wt. %, in a variety of electrolyte composition.

### Example 17—Integrated Circuit Cooling

The working fluids of the present disclosure, including Compounds 1-4 and/or Heat Transfer Compositions 1-10 and/or Blends RB1-RB20 are used to cool integrated circuits, such as computer chips, circuit boards, and/or any heat sinks or heat spreaders which are associated with or connected to the computer chips or circuit boards, by circulating Compounds 1-4 and/or Heat Transfer Compositions 1-10 and/or Blends RB1-RB20 around the integrated circuit components or immersing the integrated circuit components in Compounds 1-4 and/or Heat Transfer Compositions 1-10 and/or Blends RB1-RB20. The cooling system effectively, efficiently, safely and reliably maintains the integrated circuit components in the most desired operating temperature range.

### Example 18—Solvent Degreasing

The working fluids of the present disclosure, including Compounds 1-4 are used as the solvent in a degreasing apparatus and successfully remove various contaminants, including all of the contaminants mentioned above from a variety of substrates, including all of the substrates mentioned above.

### Aspects

Aspect 1 is a method of providing heat transfer to and/or from an electronic component, article and/or device while the device is operating comprising: providing a heat transfer composition comprising at least about 10% by weight of 3-(difluoromethoxy)-1,1,1,2,2-pentafluoropropane; and contacting the heat transfer composition with the electronic component, article and/or device while it is in operation to cool the electronic component, article and/or device.
Aspect 2 is the method of Aspect 1, wherein the heat transfer composition has a dielectric constant less than about 5 at 20 GHz.
Aspect 3 is the method of Aspect 2, wherein the heat transfer composition has a dielectric constant of about 3.4 at 20 GHz.
Aspect 4 is the method of any one of Aspects 1-3, wherein the heat transfer composition has a boiling point of from about 35° C. to about 80° C.
Aspect 5 is the method of Aspect 4, wherein the heat transfer composition has a boiling point of about 46° C.
Aspect 6 is the method of any one of Aspects 1-5, wherein the heat transfer composition has a global warming potential (GWP) of about 500 or less.
Aspect 7 is the method of any one of Aspect 1-6, wherein the heat transfer composition is non-flammable.
Aspect 8 is the method of any one of Aspects 1-7, wherein the heat transfer composition comprises at least about 50% by weight of 3-(difluoromethoxy)-1,1,1,2,2-pentafluoropropane.
Aspect 9 is the method of any one of Aspects 1-8, wherein the electronic device is selected from a data center and a battery.
Aspect 10 is a method of heating and/or cooling an electronic component, article and/or device comprising: (a) providing a refrigerant comprising at least about 10% by weight of 3-(difluoromethoxy)-1,1,1,2,2-pentafluoropropane; (b) immersing the electronic component, article and/or device while the electronic, article and/or device is operating in the refrigerant; and (c) transferring heat between the immersed electronic component, article and/or device and the refrigerant.
Aspect 11 is the method of Aspect 10, wherein the refrigerant has a dielectric constant less than about 5 at 20 GHz.
Aspect 12 is the method of Aspect 11, wherein the refrigerant has a dielectric constant of about 3.4 at 20 GHz.
Aspect 13 is the method of any one of Aspects 10-12, wherein the refrigerant has a boiling point of from about 35° C. to about 80° C.
Aspect 14 is the method of Aspect 13, wherein the refrigerant has a boiling point of about 46° C.
Aspect 15 is the method of any one of Aspects 10-14, wherein the refrigerant has a global warming potential (GWP) of about 500 or less.
Aspect 16 is the method of any one of Aspects 10-15, wherein the refrigerant is non-flammable.
Aspect 17 is the method of any one of Aspects 10-16, wherein the refrigerant comprises at least about 50% by weight of 3-(difluoromethoxy)-1,1,1,2,2-pentafluoropropane.
Aspect 18 is the method of any one of Aspects 10-17, wherein the electronic device is selected from a data center and a battery.
Aspect 19 is a method for synthesizing 3-(difluoromethoxy)-1,1,1,2,2-pentafluoropropane, comprising reacting 2,2,3,3,3-pentafluoro-1-propanol with chlorodifluoromethane in the presence of a base.
Aspect 20 is the method of Aspect 19, further comprising at least one of the following: the reacting step is in the presence of an organic solvent selected from diglyme, dioxane, and a combination thereof; the base is NaOH; and the reacting step is carried out at a temperature from about 10° C. to about 45° C.
Aspect 21 is a composition comprising a fluoroether according to Formula 1:

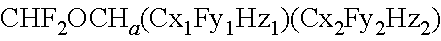

wherein a=1 or 2;
x₁ is from 1 to 4;
y₁ is from 3 to 9;
z₁ is from 0 to 6;
x₂ is from 0 to 3;
y₂ is from 0 to 7; and
z₂ is from 0 to 4.
Aspect 22 is the composition of Aspect 21, wherein the fluoroether comprises at least one of:
3-(difluoromethoxy)-1,1,2,2-tetrafluoropropane (CHF₂CF₂CH₂OCHF₂),
3-(difluoromethoxy)-1,1,1,2,2-pentafluoropropane (CF₃CF₂CH₂OCHF₂),
2-(difluoromethoxy)-1,1,1,3,3,3-hexafluoropropane ((CF₃)2CHOCHF₂),
4-(difluoromethoxy)-1,1,1,2,2,3,3-heptafluorobutane (CF₃CF₂CF₂CH₂OCHF₂),
and combinations of the foregoing
Aspect 23 is a heat transfer composition comprising the fluoroether composition of Aspect 21 or Aspect 22.
Aspect 24 is a thermal management composition comprising the fluoroether composition of Aspect 21 or Aspect 22.
Aspect 25 is an electrolyte composition comprising the fluoroether composition of Aspect 21 or Aspect 22.
Aspect 26 is a solvent composition comprising the fluoroether composition of Aspect 21 or Aspect 22.
Aspect 27 is a method for synthesizing a fluoroether according to Formula 1:

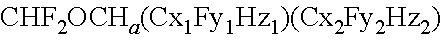

wherein a=1 or 2;
x₁ is from 1 to 4;
y₁ is from 3 to 9;
z₁ is from 0 to 6;
x₂ is from 0 to 3;
y₂ is from 0 to 7; and
z₂ is from 0 to 4.
comprising reacting a fluoroalcohol with chlorodifluoromethane in the presence of a catalyst to provide the fluoroether of Formula 1.
Aspect 28 is the method of Aspect 27, wherein the fluoroalcohol is 2,2,3,3-tetrafluoro-1-propanol and the fluoroether is 3-(difluoromethoxy)-1,1,2,2-tetrafluoropropane
Aspect 29 is the method of Aspect 27, wherein the fluoroalcohol is 2,2,3,3,3-pentafluoro-1-propanol and the fluoroether is 3-(difluoromethoxy)-1,1,1,2,2-pentafluoropropane.
Aspect 30 is the method of Aspect 27, wherein the fluoroalcohol is 2,2,2,3,3,3-hexafluoro-1-propanol, and the fluoroether is 2-(difluoromethoxy)-1,1,1,3,3,3-hexafluoropropane.
Aspect 31 is the method of Aspect 27, wherein the fluoroalcohol is 2,2,3,3,4,4,4-heptafluoro-1-butanol, and the fluoroether is 4-(difluoromethoxy)-1,1,1,2,2,3,3-heptafluorobutane.
Aspect 32 is the method of any of Aspects 27-31, wherein the reacting step further comprises reacting in the presence of an organic solvent.
Aspect 33 is the method of Aspect 32, wherein the organic solvent is selected from diglyme, dioxane, and a combination thereof.
Aspect 34 is the method of any of Aspects 27-31, wherein the catalyst is NaOH.
Aspect 35 is the method of any of Aspects 27-31, wherein the reaction step further comprises carrying out the reaction at a temperature from 10 to 45° C.
Aspect 36 is a method of cooling an operating electronic device comprising: providing a refrigerant comprising a fluoroether according to Formula 1:

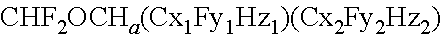

wherein a=1 or 2;
x₁ is from 1 to 4;
y₁ is from 3 to 9;
z₁ is from 0 to 6;
x₂ is from 0 to 3;
y₂ is from 0 to 7;
z₂ is from 0 to 4; and
immersing an electronic device or component in the refrigerant.
Aspect 37 is the method of Aspect 36, wherein the refrigerant has a global warming potential (GWP) of about 200 or less.
Aspect 38 is the method of Aspect 36 or Aspect 37, wherein the refrigerant is non-flammable.
Aspect 39 is the method of any of Aspects 36-38, wherein the refrigerant has a dielectric constant less than 5 at 20 GHz.
Aspect 40 is the method of any of Aspects 36-39, wherein the refrigerant has a boiling point of from about 35° C. to about 80° C.
Aspect 41 is the method of any of Aspects 36-40 wherein the refrigerant: (i) has a dielectric constant less than 5 at 20 GHZ; (ii) has a boiling point of from about 35° C. to about 80° C.; (iii) is non-flammable; and (iv) has an Ames-negative toxicity.
Aspect 42 is the method of any of Aspects 36-41 wherein the refrigerant comprises at least about 50% by weight of a fluoroether according to Formula 1:

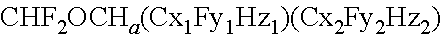

wherein a=1 or 2;
x₁ is from 1 to 4;
y₁ is from 3 to 9;
z₁ is from 0 to 6;
x₂ is from 0 to 3;
y₂ is from 0 to 7; and
z₂ is from 0 to 4.
Aspect 43 is the method of any of Aspects 36-42 wherein the electronic device or component comprises one or more of batteries, semiconductor integrated circuits (ICs), electrochemical cells, power transistors, resistors, electroluminescent elements, microprocessors, power control semiconductors, electrical distribution switch gear, power transformers, printed circuit boards, multi-chip modules, packaged or unpackaged semiconductor devices, semiconductor integrated circuits, fuel cells, lasers light emitting diodes (LEDs), electrochemical cells, electrical drive motors and combinations of these.
Aspect 44 is the method of any of Aspects 36-43 conducted in an electric vehicle and/or in a hybrid gas/electric vehicle and/or in a data center and/or in a server and/or in a crypto mining center.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances that fall within the scope of the appended claims.

1. A method of providing heat transfer to and/or from an electronic component, article and/or device while the device is operating comprising:
providing a heat transfer composition comprising at least about 10% by weight of 3-(difluoromethoxy)-1,1,1,2,2-pentafluoropropane; and
contacting the heat transfer composition with the electronic component, article and/or device while it is in operation to cool the electronic component, article and/or device.

2. The method of claim 1, wherein the heat transfer composition has a dielectric constant less than about 5 at 20 GHz.

3. The method of claim 2, wherein the heat transfer composition has a dielectric constant of about 3.4 at 20 GHz.

4. The method of claim 1, wherein the heat transfer composition has a boiling point of from about 35° C. to about 80° C.

5. The method of claim 4, wherein the heat transfer composition has a boiling point of about 46° C.

6. The method of claim 1, wherein the heat transfer composition has a global warming potential (GWP) of about 500 or less.

7. The method of claim 1, wherein the heat transfer composition is non-flammable.

8. The method of claim 1, wherein the heat transfer composition comprises at least about 50% by weight of 3-(difluoromethoxy)-1,1,1,2,2-pentafluoropropane.

9. The method of claim 1, wherein the electronic device is selected from a data center and a battery.

10. A method of heating and/or cooling an electronic component, article and/or device comprising:
(a) providing a refrigerant comprising at least about 10% by weight of 3-(difluoromethoxy)-1,1,1,2,2-pentafluoropropane;
(b) immersing the electronic component, article and/or device while the electronic, article and/or device is operating in the refrigerant; and
(c) transferring heat between the immersed electronic component, article and/or device and the refrigerant.

11. The method of claim 10, wherein the refrigerant has a dielectric constant less than about 5 at 20 GHz.

12. The method of claim 11, wherein the refrigerant has a dielectric constant of about 3.4 at 20 GHz.

13. The method of claim 10, wherein the refrigerant has a boiling point of from about 35° C. to about 80° C.

14. The method of claim 13, wherein the refrigerant has a boiling point of about 46° C.

15. The method of claim 10, wherein the refrigerant has a global warming potential (GWP) of about 500 or less.

16. The method of claim 10, wherein the refrigerant is non-flammable.

17. The method of claim 10, wherein the refrigerant comprises at least about 50% by weight of 3-(difluoromethoxy)-1,1,1,2,2-pentafluoropropane.

18. The method of claim 10, wherein the electronic device is selected from a data center and a battery.

19. A method for synthesizing 3-(difluoromethoxy)-1,1,1,2,2-pentafluoropropane, comprising reacting 2,2,3,3,3-pentafluoro-1-propanol with chlorodifluoromethane in the presence of a base.

20. The method of claim 19, further comprising at least one of the following:
the reacting step is in the presence of an organic solvent selected from diglyme, dioxane, and a combination thereof;
the base is NaOH; and
the reacting step is carried out at a temperature from about 10° C. to about 45° C.
